(19) United States
(12) Patent Application Publication
(10) Pub. No.: US 2026/0024144 A1
(43) Pub. Date: Jan. 22, 2026

(54) SYSTEMS AND METHODS FOR MODELING UNSTRUCTURED DATA ITEMS

(71) Applicant: State Farm Mutual Automobile Insurance Company, Bloomington, IL (US)

(72) Inventors: Syamala Mangalampalli, Frisco, TX (US); Stephen Prevatt, Normal, IL (US); Jeff Stoiber, Bloomington, IL (US)

(73) Assignee: State Farm Mutual Automobile Insurance Company, Bloomington, IL (US)

(21) Appl. No.: 18/905,877

(22) Filed: Oct. 3, 2024

Related U.S. Application Data
(60) Provisional application No. 63/672,185, filed on Jul. 16, 2024.
(60) Provisional application No. 63/676,809, filed on Jul. 29, 2024.

(51) Int. Cl. G06Q 40/08; G06Q 30/0204

(52) U.S. Cl. CPC G06Q 40/08; G06Q 30/0205

(57) ABSTRACT

In various examples, systems and methods are disclosed for modeling unstructured data items. The system may receive multiple unstructured data items associated with various protection records. The system may then generate a prompt based upon these data items by extracting associations. The system may use the unstructured data items and the prompt as input to one or more AI models to generate an output related to either predicting occurrences or identifying patterns. The system may determine an action to update at least one protection parameter of a protection product, with the action responding to the unstructured data items and the prompt.

### CROSS-REFERENCE TO RELATED APPLICATIONS

This application claims priority to and the benefit of U.S. Provisional Patent Application Ser. No. 63/676,809, filed Jul. 29, 2024, and U.S. Provisional Patent Application Ser. No. 63/672,185, filed Jul. 16, 2024, both of which are incorporated herein by reference in their entireties.

### FIELD OF THE INVENTION

The present disclosure generally relates to machine learning, generative artificial intelligence (AI), and/or modeling systems. More particularly, the present systems and methods relate to using a modeling system to process unstructured data items to generate insights and update parameters for various applications.

### BACKGROUND

Individuals and organizations may use various methods to manage and analyze data related to protection products. For instance, an insurer may collect and process data from insurance claims, policyholder reports, and other sources to evaluate risk and update policy terms.

However, different types of data, particularly unstructured data items such as claim notes, multimedia files, and customer communications, may pose challenges for analysis and integration. Conventional techniques may also have certain ineffectiveness, inefficiencies, encumbrances, and/or other drawbacks as well.

### BRIEF SUMMARY

A modeling system may be provided that, inter alia, processes and analyzes unstructured data items related to protection products, such as to facilitate (i) improving the accuracy of assessments, and/or (ii) enhancing decision-making for managing protection products. For instance, different types of unstructured data items, such as protection records, multimedia files, and communications, may be analyzed to identify patterns and generate insights for updating protection parameters. The modeling system may identify and/or analyze trends in the frequency and nature of protection records and generate actions for adjusting parameters and conditions based upon the model outputs derived from the unstructured data items modeling. Examples of protection records can include, but are not limited to, insurance policy records, data elements, insurance claims, claim notes, customer communications, multimedia records, premium payment histories, coverage summaries, customer feedback, policy endorsements, renewal notices, beneficiary designations, claims processing timelines, customer service interactions, policy applications, risk assessment scores, insured asset information, claims adjustment reports, policy renewal offers, or any other relevant records associated with protection products.

In one aspect, a modeling system may be provided that models unstructured data items. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another and which may be implemented as data input devices, data or analysis output devices, and/or data generating, collecting, gathering, and/or presenting devices. For example, in one instance, the computer system may include one or more memory devices having instructions stored thereon that, when executed by one or more processors, cause the one or more processors to perform operations including (1) receiving a plurality of unstructured data items associated with a plurality of protection records, the plurality of protection records corresponding to at least one protection product; (2) generating a prompt based upon the plurality of unstructured data items for one or more artificial intelligence (AI) models, wherein generating the prompt includes extracting one or more associations corresponding to contextual information and attribute information of the plurality of unstructured data items; (3) applying the plurality of unstructured data items and the prompt as input to the one or more AI models to cause the one or more AI models to generate an output regarding at least one of an occurrence prediction or a pattern identification within the plurality of unstructured data items, wherein the output includes an update to at least one protection parameter of the at least one protection product; and/or (4) determining at least one action to apply the update to the at least one protection parameter of the at least one protection product. The at least one action may include a response to the plurality of unstructured data items and the prompt, and the response may cause a tuning of a probability metric of the occurrence prediction or a tuning of a frequency metric of the pattern identification. The computer system may include additional, less, or alternate functionality and/or operations, including that discussed elsewhere herein.

For instance, in certain embodiments, the functionality and/or operations may include (i) monitoring, using at least one data feed, multimedia data of at least one protection record of the plurality of protection records, the at least one protection record corresponding to the at least one protection product. Additionally or alternatively, the functionality and/or operations may also include (ii) converting the multimedia data into the plurality of unstructured data items of the at least one protection record.

In some implementations, the plurality of unstructured data items may correspond to non-relational data generated by a plurality of sources. Additionally or alternatively, the functionality and/or operations may include (a) transforming the plurality of unstructured data items into a plurality of feature vectors; (b) normalizing the plurality of feature vectors to a scale; and/or (c) inputting the normalized plurality of feature vectors into the one or more AI models to perform predictive and/or pattern recognition to cause the one or more AI models to generate the output.

In various implementations, the one or more AI models may include a generative AI model, and/or wherein the generative AI model include at least one of (i) a supervised learning model trained on labeled protection records of the plurality of protection records, and/or (ii) an unsupervised learning model trained on unlabeled protection records of the plurality of protection records, both of which may be used in conjunction with reinforcement learning techniques.

Additionally or alternatively, the supervised learning model and/or the unsupervised learning model may include at least one of (i) an association detector to assign the probability metric of the occurrence prediction, and/or (ii) a pattern tracker to assign the frequency metric of the pattern identification. Additionally or alternatively, the generative AI model may implement reinforcement learning, wherein the reinforcement learning includes updating the generative AI model based upon receiving feedback on the output and/or the at least one action from a reward signal generated from performance metrics of the plurality of protection records, the feedback corresponding to at least one user interaction with a user interface.

In certain implementations, the update to the at least one protection parameter is at least one of updating a deductible parameter for at least one future protection product, updating a coverage parameter for the at least one future protection product, updating a product exclusion parameter for the at least one future protection product, updating a processing protocol parameter for the at least one future protection product, or generating a new query for the at least one future protection product.

In some implementations, the response causing the tuning of the probability metric includes reducing the probability metric corresponding with reducing a probability of a future protection record, and/or wherein the response causing the tuning of the frequency metric of the pattern identification includes updating the frequency metric corresponding with a persistence probability of a subset of the plurality of protection records.

In various implementations, the one or more associations extracted from the plurality of unstructured data items may include identifying correlations between the plurality of unstructured data items of the plurality of protection records, and/or wherein the contextual information corresponds to circumstantial factors and/or environmental factors of each of the plurality of protection records, and/or the attribute information corresponds to attributes and/or properties of each of the plurality of protection records.

In certain embodiments, the functionality and/or operations may include (a) in response to generating the output regarding at least one of the occurrence prediction or the pattern identification within the plurality of protection records, determining additional data to apply as the input to the one or more AI models. The functionality and/or operations may also include (b) requesting or accessing, from at least one data feed, additional data corresponding to the plurality of protection records. For instance, in certain embodiments, the functionality and/or operations may include causing a user interface to display the output including a prompt element for receiving user input.

In various implementations, the functionality and/or operations may include (a) generating, during an active session between a plurality of users, a query according to the at least one action, the active session includes an active connection between a first computing system of a first user and a second computing system of a second user. The functionality and/or operations may also include (b) causing the user interface to display the query to at least the first computing system or the second computing system.

In another aspect, a modeling system may be provided that models unstructured data items. The modeling system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another, and which may employed as data input and/or output devices, data generation or collection devices, and/or data analysis presentation devices. For example, in one instance, the modeling system may include one or more memory devices having instructions stored thereon that, when executed by one or more processors, cause the one or more processors to perform operations including (1) monitoring, using at least one data feed, multimedia data associated with at least one protection record, the at least one protection record corresponding to at least one protection product; (2) converting the multimedia data into a plurality of data items of the at least one protection record; (3) generating a prompt based upon the plurality of data items for one or more artificial intelligence (AI) models, wherein generating the prompt includes extracting one or more associations corresponding to contextual information and attribute information of the plurality of data items; (4) applying the plurality of data items and the prompt as input to the one or more AI models to cause the one or more AI models to generate an output regarding at least one of an occurrence prediction or a pattern identification within the plurality of data items, wherein the output includes an update to at least one protection parameter of the at least one protection product; and/or (5) determining at least one action to apply the update to the at least one protection parameter of the at least one protection product. The at least one action may include a response to the plurality of data items and the prompt, the response causing a tuning of a probability metric of the occurrence prediction or a tuning of a frequency metric of the pattern identification. The modeling system may include additional, less, or alternate functionality, including that discussed elsewhere herein.

In some implementations, the plurality of unstructured data items may correspond to non-relational data generated by a plurality of sources. Additionally or alternatively, the functionality and/or operations may include (a) transforming the plurality of data items into a plurality of feature vectors, and/or (b) normalizing the plurality of feature vectors to a scale. The functionality and/or operations may also include (c) inputting the normalized plurality of feature vectors into the one or more AI models to perform predictive and pattern recognition to cause the one or more AI models to generate the output.

In various implementations, the one or more AI models include a generative AI model, and/or wherein the generative AI model include at least one of (i) a supervised learning model trained on labeled protection records of the at least one protection record and/or (ii) an unsupervised learning model trained on unlabeled protection records of the at least one protection record. The supervised and/or unsupervised learning models may be trained and/or used in conjunction with other models, such as reinforced, reinforcement, and/or deep learning models.

In certain implementations, the supervised learning model and/or the unsupervised learning model include at least one of (i) an association detector to assign the probability metric of the occurrence prediction, and/or (ii) a pattern tracker to assign the frequency metric of the pattern identification.

In some implementations, the generative AI model implements reinforcement learning, wherein the reinforcement learning includes updating the generative AI model based upon receiving feedback on the output and/or the at least one action from a reward signal generated from performance metrics of the at least one protection record, the feedback corresponding to at least one user interaction with a user interface.

In various implementations, the update to the at least one protection parameter is at least one of updating a deductible parameter for at least one future protection product, updating a coverage parameter for the at least one future protection product, updating a product exclusion parameter for the at least one future protection product, updating a processing protocol parameter for the at least one future protection product, or generating a new query for the at least one future protection product.

In another aspect, a computer-implemented method for modeling unstructured data items. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another, and which may be used as data input or output devices. In one instance, the computer-implemented method may include, such as via one or more local or remote processors, transceivers, sensors, other electronic components, including those discussed elsewhere herein, and/or computer-readable storage media having instructions stored thereon executable by the processors, transceivers, sensors, and/or other electronic components, (1) receiving, using one or more processors and one or more computer-readable storage media having instructions stored thereon executable by the one or more processors, a plurality of unstructured data items associated with a plurality of protection records, the plurality of protection records corresponding to at least one protection product; (2) monitoring, using the one or more processors and using at least one data feed, multimedia unstructured data items associated with at least one protection record of the plurality of protection records, the at least one protection record corresponding to the at least one protection product; (3) converting, using the one or more processors, the multimedia unstructured data items into unstructured data items of the plurality of unstructured data items; (4) generating, using the one or more processors, a prompt based upon the plurality of unstructured data items for one or more artificial intelligence (AI) models, wherein generating the prompt includes extracting one or more associations corresponding to contextual information and attribute information of the plurality of unstructured data items; (5) applying, using the one or more processors, the plurality of unstructured data items and the prompt as input to the one or more AI models to cause the one or more AI models to generate an output regarding at least one of an occurrence prediction or a pattern identification within the plurality of unstructured data items, wherein the output includes an update to at least one protection parameter of the at least one protection product; and/or (6) determining, using the one or more processors, at least one action to apply the update to the at least one protection parameter of the at least one protection product, wherein the at least one action includes a response to the plurality of unstructured data items and the prompt, the response causing a tuning of a probability metric of the occurrence prediction or a tuning of a frequency metric of the pattern identification. The method may include additional, less, or alternate functionality, including that discussed elsewhere herein.

In certain embodiments, the one or more AI models include a generative AI model, and wherein the generative AI model include at least one of (i) a supervised learning model trained on labeled protection records of the plurality of protection records, and/or (ii) an unsupervised learning model trained on unlabeled protection records of the plurality of protection records.

In yet another aspect, a computer-implemented method for modeling unstructured data items. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another, and which may be used as data input or output devices. In one instance, the computer-implemented method may include, such as via one or more local or remote processors, transceivers, sensors, other electronic components, including those discussed elsewhere herein, and/or computer-readable storage media having instructions stored thereon executable by the processors, transceivers, sensors, and/or other electronic components, (1) receiving historical claim data from at least one of one or more sensors or one or more databases; (2) processing the historical claim data using a trained generative AI and/or machine learning model to identify at least one of (i) one or more baseline claims or (ii) one or more emerging trends in claims of the historical claim data; (3) receiving new claim data in real-time from one or more sources, the new claim data associated with a plurality of customer devices; (4) processing the new claim data using the trained generative AI or machine learning model to identify at least one of (i) one or more abnormal claims or (ii) an emerging trend in new types of claims or causes of loss; (5) generating output data configured to cause the one or more abnormal claims or the emerging trend in the new types of claims or causes of loss to be displayed for user review and analysis to mitigate additional damage to customer tangible property; (6) determining one or more corrective and/or mitigative actions to reduce, mitigate, and/or prevent the one or more abnormal claims or the emerging trend in the new types of claims or causes of loss; (7) identifying one or more customers susceptible to the one or more abnormal claims or the emerging trend in the new types of claims or causes of loss; and (8) transmitting a message to the at least one customer device associated with the one or more identified customers, the message including (i) information on the one or more abnormal claims or the emerging trend in the new types of claims or causes of loss and (ii) one or more recommended corrective and/or mitigative actions. The method may include additional, less, or alternate functionality, including that discussed elsewhere herein.

In certain embodiments, the historical claim data corresponds to insurance claims data, and wherein the trained generative AI or machine learning model is trained using a dataset including labeled historical insurance claims from a plurality of data sources, includes at least one of customer reports, sensor data, or third-party information.

In some embodiments, identifying, by the trained generative AI or machine learning model, the one or more baseline claims includes modeling historical claim patterns, frequencies, and characteristics to generate a reference model, and wherein the one or more baseline claims correspond to claim patterns and frequencies in the historical claim data or identifying, by the trained generative AI or machine learning model, the one or more emerging trends in claims of the historical claim data includes modeling deviations from the one or more baseline claims, including increases in specific claim types or new claim patterns, and wherein the one or more emerging trends in claims of the historical claim data correspond to the new claim patterns or increased frequencies of the specific claim types indicating the one or more emerging trends.

In various implementations, the new claim data includes at least one of (i) real-time sensor data (including image or audio data from mobile devices, smart home sensors, smart vehicle sensors, smart infrastructure sensors, drone sensors, etc.), (ii) customer reports or other customer-related data (including insured asset data), or (iii) third-party information, and wherein processing the new claim data using the trained generative AI and/or machine learning model includes preprocessing and normalizing the new claim data.

In various embodiments, identifying, by the trained generative AI or machine learning model, the one or more abnormal claims includes detecting claims that (i) deviate from at least one of the one or more baseline claims or (ii) correspond to the one or more emerging trends or identifying, by the trained generative AI or machine learning model, the emerging trend in the new types of claims or causes of loss includes analyzing a frequency, severity, context, and characteristics of the new types of claims or causes of loss, including whether insured assets are a total loss.

In certain embodiments, generating the output data configured to cause the one or more abnormal claims or the emerging trend in the new types of claims or causes of loss includes generating and transmitting a visualization, report, or alert for presentation, and wherein mitigating additional damage to customer tangible property corresponds to performing a future action.

In some implementations, the one or more corrective and/or mitigative actions may include, for example, at least one of (i) issuing warnings to the one or more identified customers, (ii) updating an insurance coverage term, (iii) initiating an inspection, (iv) scheduling maintenance, (v) scheduling repair or replacement work, (vi) ordering repair or replacement parts, appliances, or materials for a customer, or (vi) deploying a risk mitigation resource. Determining one or more corrective and/or mitigative actions to reduce the one or more abnormal claims or the emerging trend in the new types of claims or causes of loss may include (a) analyzing an effectiveness of a plurality of measures and implementing at least one of the plurality of measure; (b) implementing one or more mitigative measures; and/or (c) determining one or more corrective and/or mitigative actions to prevent or mitigate the one or more abnormal claims or the emerging trend in the new types of claims or causes of loss includes a preemptive measures.

In some embodiments, identifying one or more customers susceptible to the one or more abnormal claims or the emerging trend in the new types of claims or causes of loss includes analyzing at least one of (i) customer profiles, (ii) customer assets and insured assets, (iii) customer asset data, such as home data, appliance data, vehicle data, inventory lists, etc., (iv) the historical claim data, or (v) the new claim data to identify the one or more customers or the customer tangible property at increased risk of the one or more abnormal claims or the emerging trend in the new types of claims or causes of loss.

For instance, if a problem or issue is identified with a certain type of dishwasher or refrigerator, customer asset or personal article data may be analyzed to determine which customers own that type of dishwasher or refrigerator. Then, a warning message may be transmitted to those customers' mobile devices with recommended corrective actions, and repair or replacement parts or appliances ordered (e.g., faulty solenoids or electrical wiring). Proposed maintenance or repair service times may be sent to the customers' mobile devices to facilitate ease of repair or replacement, as well as preventing or mitigating further damage to the home or appliances.

As another example, a type of smart vehicle's autonomous or semi-autonomous feature or system (e.g., automatic braking, lane assist, etc.) may be deemed faulty or in need of upgrade or repair. Customers having that type of smart vehicle autonomous or semi-autonomous feature or system may be identified by analysis of customer asset data or the like. Once identified, those customers may be notified via their mobile device along with recommendations to repair or replace the faulty feature or system. For example, maintenance at a repair facility or dealership may be automatically scheduled for the customer or with the customer's review and approval.

As another example, if faulty home construction or construction material is identified, impacted customers may be identified via analysis of customer asset data or the like, such as a review of a home profile or inventory list. Impacted customers may be notified via their mobile devices, along with recommendations to prevent or mitigate home damage. For instance, repair or replacement materials (such as shingles or drywall) may be ordered for the customer. Repair work by a service provider may be scheduled for the customer, either automatically or with the customers' approval via their mobile device.

In yet another aspect, a modeling system may be provided that identifies emerging trends in insurance claims and mitigating damage. The modeling system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another, and which may employed as data input and/or output devices, data generation or collection devices, and/or data analysis presentation devices. For example, in one instance, the modeling system may include one or more memory devices having instructions stored thereon that, when executed by one or more processors, cause the one or more processors to perform operations including (1) receiving historical claim data from at least one of one or more sensors or one or more databases; (2) processing the historical claim data using a trained generative AI and/or machine learning model to identify at least one of (i) one or more baseline claims or (ii) one or more emerging trends in claims of the historical claim data; (3) receiving new claim data in real-time from one or more sources, the new claim data associated with a plurality of customer devices; (4) processing the new claim data using the trained generative AI or machine learning model to identify at least one of (i) one or more abnormal claims or (ii) an emerging trend in new types of claims or causes of loss; (5) generating output data configured to cause the one or more abnormal claims or the emerging trend in the new types of claims or causes of loss to be displayed for user review and analysis to mitigate additional damage to customer tangible property; (6) determining one or more corrective and/or mitigative actions to reduce, mitigate, and/or prevent the one or more abnormal claims or the emerging trend in the new types of claims or causes of loss; (7) identifying one or more customers susceptible to the one or more abnormal claims or the emerging trend in the new types of claims or causes of loss; and/or (8) transmitting a message to the at least one customer device associated with the one or more identified customers, the message including (i) information on the one or more abnormal claims or the emerging trend in the new types of claims or causes of loss and/or (ii) one or more recommended corrective and/or mitigative actions. The modeling system may include additional, less, or alternate functionality, including that discussed elsewhere herein.

In some implementations, the historical claim data corresponds to insurance claims data, and wherein the trained generative AI or machine learning model is trained using a dataset including labeled historical insurance claims from a plurality of data sources, includes at least one of customer reports, sensor data (including video, image, and audio data), or third-party information.

In various embodiments, identifying, by the trained generative AI or machine learning model, the one or more baseline claims includes modeling at least one of historical claim patterns, frequencies, or characteristics to generate a reference model, and wherein the one or more baseline claims correspond to claim patterns and/or frequencies in the historical claim data or identifying, by the trained generative AI or machine learning model, the one or more emerging trends in claims of the historical claim data includes modeling deviations from the one or more baseline claims, including increases in specific claim types or new claim patterns, and wherein the one or more emerging trends in claims of the historical claim data correspond to the new claim patterns or increased frequencies of the specific claim types indicating the one or more emerging trends.

In some implementations, the new claim data includes at least one of (i) sensor data, (ii) customer reports, or (iii) third-party information, and wherein processing the new claim data using the trained generative AI and/or machine learning model includes preprocessing and normalizing the new claim data.

In some implementations, identifying, by the trained generative AI or machine learning model, the one or more abnormal claims includes detecting claims that (i) deviate from at least one of the one or more baseline claims or (ii) correspond to the one or more emerging trends; or identifying, by the trained generative AI or machine learning model, the emerging trend in the new types of claims or causes of loss includes analyzing at least one of a frequency, context, or characteristics of the new types of claims or causes of loss.

In some embodiments, generating the output data configured to cause the one or more abnormal claims or the emerging trend in the new types of claims or causes of loss includes generating and transmitting a visualization, report, or alert for presentation, and wherein mitigating additional damage to customer tangible property corresponds to performing a future action.

In some implementations, the one or more corrective and/or mitigative actions includes at least one of (i) issuing warnings to the one or more identified customers, (ii) updating an insurance coverage term, (iii) initiating an inspection, or (iv) deploying a risk mitigation resource, determining one or more corrective and/or mitigative actions to reduce the one or more abnormal claims or the emerging trend in the new types of claims or causes of loss includes analyzing an effectiveness of a plurality of measures and implementing at least one of the plurality of measures, determining one or more corrective and/or mitigative actions to mitigate the one or more abnormal claims or the emerging trend in the new types of claims or causes of loss includes implementing one or more mitigative measures, determining one or more corrective and/or mitigative actions to prevent the one or more abnormal claims or the emerging trend in the new types of claims or causes of loss includes a preemptive measures.

In various embodiments, identifying one or more customers susceptible to the one or more abnormal claims or the emerging trend in the new types of claims or causes of loss includes analyzing at least one of (i) customer profiles, (ii) the historical claim data, or (iii) the new claim data to identify the one or more customers or the customer tangible property at increased risk of the one or more abnormal claims or the emerging trend in the new types of claims or causes of loss.

In yet another aspect, a non-transitory computer readable medium may include instructions stored thereon that, when executed by one or more processors, cause the one or more processors to perform operations, including (1) receiving historical claim data from at least one of one or more sensors or one or more databases; (2) processing the historical claim data using a trained generative AI and/or machine learning model to identify at least one of (i) one or more baseline claims or (ii) one or more emerging trends in claims of the historical claim data; (3) receiving new claim data in real-time from one or more sources, the new claim data associated with a plurality of customer devices; (4) processing the new claim data using the trained generative AI or machine learning model to identify at least one of (i) one or more abnormal claims or (ii) an emerging trend in new types of claims or causes of loss; (5) generating output data configured to cause the one or more abnormal claims or the emerging trend in the new types of claims or causes of loss to be displayed for user review and analysis to mitigate additional damage to customer tangible property; (6) determining one or more corrective and/or mitigative actions to reduce, mitigate, and/or prevent the one or more abnormal claims or the emerging trend in the new types of claims or causes of loss; (7) identifying one or more customers susceptible to the one or more abnormal claims or the emerging trend in the new types of claims or causes of loss; and/or (8) transmitting a message to the at least one customer device associated with the one or more identified customers, the message including (i) information on the one or more abnormal claims or the emerging trend in the new types of claims or causes of loss and/or (ii) one or more recommended corrective and/or mitigative actions. The instructions may direct additional, less, or alternate functionality, including that discussed elsewhere herein.

In various embodiments, the historical claim data corresponds to insurance claims data, and wherein the trained generative AI or machine learning model is trained using a dataset including labeled historical insurance claims from a plurality of data sources, includes at least one of customer reports, sensor data, or third-party information.

In various implementations, identifying, by the trained generative AI or machine learning model, the one or more baseline claims includes modeling at least one of historical claim patterns, frequencies, or characteristics to generate a reference model, and wherein the one or more baseline claims correspond to claim patterns and/or frequencies in the historical claim data or identifying, by the trained generative AI or machine learning model, the one or more emerging trends in claims of the historical claim data includes modeling deviations from the one or more baseline claims, including increases in specific claim types or new claim patterns, and wherein the one or more emerging trends in claims of the historical claim data correspond to the new claim patterns or increased frequencies of the specific claim types indicating the one or more emerging trends.

In some embodiments, the new claim data includes at least one of (i) sensor data, (ii) customer reports, or (iii) third-party information, and wherein processing the new claim data into using trained generative AI and/or machine learning model includes preprocessing and normalizing the new claim data.

Advantages will become more apparent to those skilled in the art from the following description of embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 is a block diagram of an exemplary modeling system, according to some embodiments.

FIG. 2 is a flow diagram of an exemplary computer-implemented or computer-based process of modeling unstructured data items, according to some embodiments.

FIG. 3 is a flow diagram of an exemplary computer-implemented or computer-based process of modeling unstructured data items, according to some embodiments.

FIG. 4 is an exemplary data flow for modeling unstructured data items, according to some embodiments.

FIGS. 5A and 5B are exemplary data flows for modeling unstructured data items, according to some embodiments.

FIG. 6 is a block diagram illustrating an exemplary computing system suitable for use in the various embodiments described herein.

FIG. 7 is a flow diagram of an exemplary computer-implemented or computer-based process of model training, according to some embodiments.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments relate to, inter alia, a computer system for processing and analyzing unstructured data items related to protection products. For instance, a plurality of unstructured data items sources (e.g., claim notes, customer communications, multimedia records) may be analyzed to identify patterns, trends, and insights that inform updates to protection parameters. A prompt may be generated based upon this analysis and applied to one or more artificial intelligence (AI) models to produce outputs regarding occurrence predictions or pattern identifications. These outputs may include updates to protection parameters that may enhance the overall effectiveness and personalization of coverage based on the insights derived from the unstructured data items analysis.

As an example, insurance claim files may include a wealth of information on specific causes of loss, such as causes of loss for automobile collisions or homeowners claims. For instance, causes of loss may include water, rain, fire, weather, storm surge, high winds, road conditions, construction, construction material or type, shingle type, etc. For example, certain home construction materials, such as sub-par dry wall, paint, or roofing materials, may exhibit an emerging trend in homeowners claims in certain geographical regions. Alternatively, a home may be subject to cyber security attacks, such as due to sub-par security software installed on a smart home network or smart devices located throughout the home. Additionally, a type of new or other vehicle may begin experiencing a trend in auto claims, such as caused by sub-par parts, manufacturing, security systems, battery charging systems, steering systems, tires, smart or autonomous vehicle features or systems, deficient cyber security, etc.

A generative AI model may be trained using historical claims data, claim notes, images from customer mobile devices, home sensors, vehicle sensors, etc., to identify abnormal or emerging trends in types of causes of loss leading to insurance claims, including causes of loss leading to homeowner claims or automobile claims. The trained AI model may then be feed new claims notes, claims data, customer reports and data with customer permission, manufacturer reports, industry news, etc. to identify emerging loss trends, triggers, frequency of occurrence, etc. to catch the causes early and take action to reduce, mitigate, and/or prevent the amount of total losses, such as nationwide losses. The generative AI analysis may also include identifying opportunities to enhance coverage options and add beneficial endorsements based on the insights gained.

In one aspect, a computer-implemented method of identifying emerging trends in insurance claims and mitigating damage, the method may include, via one or more processors, transceivers, sensors, servers, memory units, computing devices, etc. (1) receiving historical claim data (such as homeowners or auto claim data) from at least one of one or more sensors or one or more databases (such as home-mounted sensors, smart vehicle sensors, smart infrastructure, customer mobile devices, etc.); (2) processing the historical claim data using a generative AI and/or machine learning model to identify normal/baseline claims and/or emerging trends in claims; (3) receiving new claim data in real-time from one or more sources and associated with numerous customers, such as home sensors, vehicle sensors, mobile devices, claim notes, etc.; (4) feeding the new claim data into the trained generative AI to identify abnormal claims and/or an emerging trend in new types of claims and/or causes of loss (such as faulty home construction material, faulty vehicle parts or systems, or sub-pay cyber security software); (5) generating output data configured to cause the abnormal claims, or new types of causes of loss to be displayed for user review and further analysis to mitigate further damage to customer belongings, homes, vehicles, etc.; (6) determining one or more corrective and/or mitigative actions to reduce, mitigate, and/or prevent the new type of cause of loss; (7) identifying one or more customers susceptible to the new type of cause of loss, such as via review of insurance policy data or customer information; and/or (8) transmitting a message to the one or more customers susceptible to the new type of cause of loss to the customer's mobile device detailing the recommended corrective and/or mitigative action(s).

OVERVIEW

Referring to the Figures, computer systems and computer-implemented methods for processing and analyzing unstructured data items related to protection products may be provided.

For example, the computer system may be configured to receive a plurality of unstructured data items associated with protection records (e.g., claim notes, customer communications, reports, multimedia). For instance, customer data or conversations may be used for analysis with customer permission. The system may process this unstructured data items to identify patterns, trends, and insights that may inform updates to protection parameters.

Using the unstructured data items, the computer systems and computer-implemented methods may generate prompts for one or more artificial intelligence (AI) models. For instance, the AI models may be generative AI (GenAI) models. The prompts may extract associations corresponding to contextual and attribute information within the unstructured data items (e.g., time of incident, type of damage, location). The GenAI models may analyze these prompts to generate outputs, such as occurrence predictions or pattern identifications.

In certain embodiments, the updates to protection parameters are selected based upon the analysis of the unstructured data items and the generated prompts. Advantageously, the computer systems and computer-implemented methods described herein may improve the accuracy of predictions and the effectiveness of protection products by leveraging insights derived from diverse unstructured data items sources (e.g., text, images, videos).

The computer systems and computer-implemented methods have facilitated the advancements in the analysis of unstructured data items from various sources related to protection products. For example, an insurance company may collect unstructured data items from claim notes, images, videos, and customer communications. Similarly, protection service providers may gather data from various reports, assessments, and third-party sources to inform their protection offerings.

Similarly, analyzing unstructured data items using the computer systems and computer-implemented methods described herein may provide more efficient deployment of computing resources. For instance, by processing a plurality of unstructured data items associated with protection records, the system may optimize the use of processing power and storage. This may include dynamically allocating computational resources to the most critical tasks, such as real-time data analysis and model training, thereby improving system performance and reducing latency. By leveraging insights derived from unstructured data items, the modeling system ensures that computing resources are utilized effectively, improving operational efficiency.

Furthermore, analyzing unstructured data items may facilitate improved response to disasters by identifying insights that would otherwise remain unidentified. For instance, the computer systems and computer-implemented methods may process data from various sources, such as social media posts, emergency calls, and sensor data, to detect emerging threats and prioritize response efforts. By generating actionable insights from this data, computing resources may be allocated to selectively address tasks, such as resolving customer complaints, performing predictive maintenance, and updating protection parameters. This capability enhances overall operational responsiveness and effectiveness, ensuring that resources are directed to where they are most needed and improving decision-making processes by models.

In addition to improving prediction accuracy, analyzing unstructured data items may provide deeper insights into protection records, facilitating improved AI outputs and enhanced protection parameters. While traditional data analysis methods may focus on structured data (e.g., numerical data, predefined fields), integrating unstructured data items analysis may reveal hidden patterns and correlations that impact protection strategies. As such, it is advantageous to have a computer system capable of processing and analyzing unstructured data items to enhance the configuration and management of protection products.

Advantageously, one aspect of the computer systems and computer-implemented methods described herein may enhance the process for configuring protection products. For example, by assessing unstructured data items related to claims, customer interactions, and external reports (e.g., weather data, police reports), the computer systems and computer-implemented methods may identify trends and generate recommendations for updating protection parameters. This process may lead to more accurate protection modeling and improved protection implementations.

Similarly, by assessing unstructured data items from various sources, the computer systems and computer-implemented methods described herein may generate insights that inform protection product updates (e.g., new coverage options, revised underwriting criteria, updating advertisements). This includes identifying recurring issues, emerging risks, and opportunities for improving protection offerings. The integration of unstructured data items analysis into protection management may enhance the effectiveness of protection products.

As a result, protection providers may optimize their products and services based upon data-driven insights. By analyzing unstructured data items, protection parameters may be optimized to offer better alignment with current trends and enhance the relevance and effectiveness of protection products. This data-driven approach to protection management may lead to better outcomes for both providers and customers.

Advantageously, one aspect of the computer systems and computer-implemented methods described herein may allow protection providers to offer more tailored and effective protection solutions. For instance, by analyzing unstructured data items related to customer claims and interactions (e.g., feedback forms, service call transcripts), the computer systems and computer-implemented methods may identify specific needs and preferences, allowing for more personalized protection offerings. This may lead to increased customer satisfaction and improved protection outcomes.

Further, the computer systems and computer-implemented methods described herein may be configured to provide protection providers with actionable insights based upon the analysis of unstructured data items (e.g., predictive modeling, trend analysis). This may include recommendations for adjusting protection parameters, identifying emerging risks, and optimizing protection strategies. By leveraging the power of unstructured data items analysis, protection providers may enhance their decision-making processes and improve the effectiveness of their protection products.

Exemplary Analytics System with Modeling System

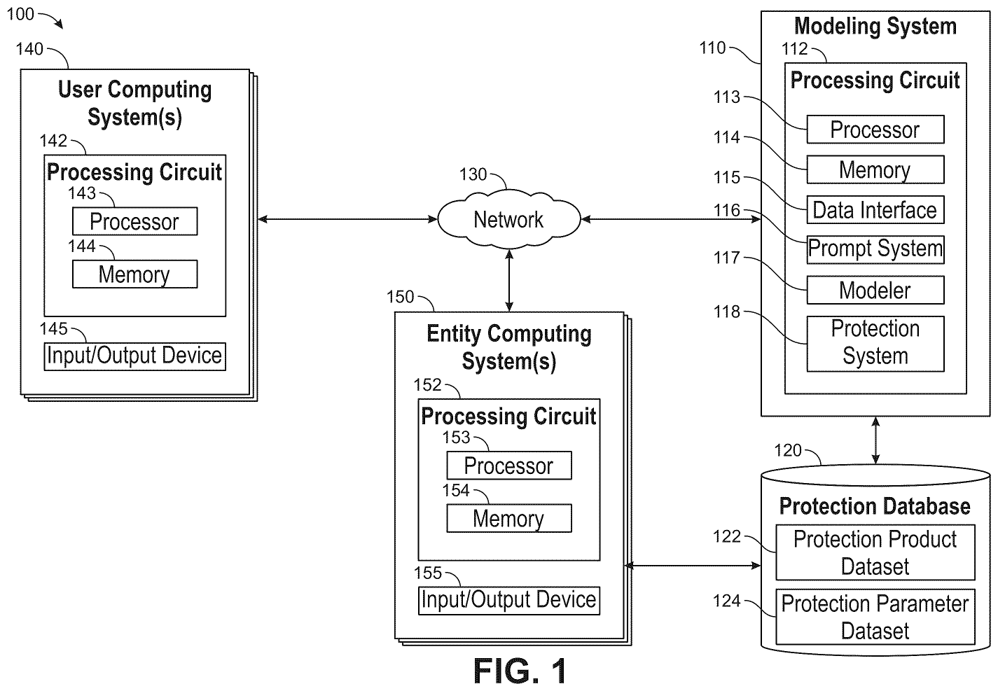

Referring to FIG. 1, a block diagram of an exemplary analytics system, shown as analytics system 100, is shown, according to some embodiments. The analytics system 100 may include a modeling system, shown as modeling system 110 having a processing circuit 112, processor 113, memory 114, data interface 115, prompt system 116, modeler 117, and protection system 118.

The analytics system 100 may also include a protection database 120 having a protection product dataset 122 and a protection parameter dataset 124. The analytics system 100 may also include a user computing system, shown as user computing system 140 having a processing circuit 142, processor 143, memory 144, and input/output device 145. The analytics system 100 may also include an entity computing system, shown as entity computing system 150 having a processing circuit 152, processor 153, memory 154, and input/output device 145.

The components of the analytics system 100 may be connected, or in wired or wireless communication, via a network 130. It should be noted that the number and type of components shown is merely illustrative and, in various implementations, implementations of the analytics system 100 may have additional, fewer, and/or different components than those illustrated in FIG. 1 including those mentioned elsewhere herein.

The components of the analytics system 100 may be connected, or in communication, via a network 130. Network 130 may include computer networks such as the Internet, local, wide, metro or other area networks, intranets, satellite networks, other computer networks such as voice or data mobile phone communication networks, combinations thereof, or any other type of electronic communications network. Network 130 may include or constitute a display network. In some implementations, network 130 facilitates secure communication between components of analytics system 100.

As a non-limiting example, network 130 may implement transport layer security (TLS), secure sockets layer (SSL), hypertext transfer protocol secure (HTTPS), and/or any other secure communication protocol. It should be noted that the number and type of components shown are merely illustrative, and in various embodiments, implementations of the analytics system 100 may have additional, fewer, and/or different components than those illustrated in FIG. 1.

The network 130 may facilitate communication between various nodes, such as the data modeling system 110, the user computing system 140, the entity computing system 150, and the protection database 120. In some implementations, data flows through the network 130 from a source node to a destination node as a flow of data packets, e.g., in the form of data packets in accordance with the Open Systems Interconnection (OSI) layers. A flow of packets may use, for example, an OSI layer-4 transport protocol such as the User Datagram Protocol (UDP), the Transmission Control Protocol (TCP), or the Stream Control Transmission Protocol (SCTP), transmitted via the network 130 layered over an OSI layer-3 network protocol such as Internet Protocol (IP), e.g., IPv4 or IPv6.

The network 130 may be composed of various network devices (nodes) that are communicatively linked to form one or more data communication paths between participating devices. Each networked device includes at least one network interface for receiving and/or transmitting data, typically as one or more data packets. An illustrative network 130 is the Internet; however, other networks may be used. The network 130 may be an autonomous system (AS), i.e., a network that is operated under a consistent unified routing policy (or at least appears to be from outside the AS network) and is generally managed by a single administrative entity (e.g., a system operator, administrator, or administrative group).

Generally, the modeling system 110, user computing system 140, entity computing system 150, and protection database 120 may include one or more logic devices, which may be one or more computing devices equipped with one or more processing circuits (e.g., processing circuit(s) 112, processing circuit(s) 142, and/or processing circuit(s) 152) that run instructions stored in a memory device (e.g., memory 114, memory 144, and/or memory 154) to perform various operations. The processing circuit may be made up of various components such as a microprocessor, an ASIC, or an FPGA, and the memory device may be any type of storage or transmission device capable of providing program instructions.

The instructions may include code from various programming languages commonly used in the industry, such as high-level programming languages, web development languages, and system programming languages. The modeling 110, user computing system 140, and entity computing system 150 may also include one or more databases for storing data, such as protection database 120, that receive and provide data to other systems and devices on the network 130.

Each system or device in analytics system 100 may include one or more processors, memories, network interfaces (sometimes referred to herein as a “network circuit”) and user interfaces. The memory (e.g., memory 114, memory 144, and/or memory 154) may store programming logic that, when executed by the processor (e.g., processor(s) 113, processor(s) 143, and/or processor(s) 153) controls the operation of the corresponding computing system or device. The memory may also store data in databases. For instance, memory 114 may store programming logic that when executed by processor 113 within processing circuit 112, causes protection database 120 to update protection parameters.

The network interfaces may allow the computing systems and devices to communicate wirelessly or otherwise. The various components of devices in analytics system 100 may be implemented via hardware (e.g., circuitry), software (e.g., executable code), or any combination thereof. Devices, systems, and components in FIG. 1 may be added, deleted, integrated, separated, and/or rearranged in various embodiments of the disclosure.

As will be discussed in greater detail below, the modeling system 110 may be configured to receive a plurality of data items associated with a plurality of protection records. For example, a plurality of protection records may correspond to at least one protection product (e.g., homeowner's policies, automotive or vehicle policies, health policies, life policies, renters' policies, personal articles or personal belongings policies, umbrella policies, parametric policies, various endorsements, etc.). The modeling system 110 may also be configured to monitor, using at least one data feed, multimedia data associated with at least one protection record. The modeling system 110 may also be configured to convert the multimedia data into a plurality of data items of the at least one protection record.

The modeling system 110 may also be configured to generating a prompt based upon the plurality of data items for one or more artificial intelligence (AI) models. For instance, generating the prompt may include extracting one or more associations corresponding to contextual information and attribute information of the plurality of data items. The modeling system 110 may also be configured to apply the plurality of data items and the prompt as input to the one or more AI models to cause the one or more AI models to generate an output regarding at least one of an occurrence prediction or a pattern identification within the plurality of data items. For example, the output may include an update to at least one protection parameter of the at least one protection product.

The modeling system 110 may also be configured to determine at least one action to apply the update to the at least one protection parameter of the at least one protection product. For instance, the at least one action may include a response to the plurality of data items and the prompt. In this example, the response may cause a tuning of a probability metric of the occurrence prediction or a tuning of a frequency metric of the pattern identification.

Referring to unstructured data items generally, oftentimes insurers, claims adjusters, or underwriters receive protection records (e.g., claims) with structured information (e.g., fields of claim submission, policy numbers, claim dates). However, protection records oftentimes include unstructured information provided by the claim handlers, adjusters, and insured. However, this unstructured information typically lacks standardized formatting and consistency. As described in various embodiments herein, the modeling system 110 may process and analyze this unstructured data items to extract meaningful patterns and insights.

For example, when home insurance claims are submitted, the insurance claim may have structured data, such as, a type of loss, type of car, make of car, location of the house, policy number, claim amount, date of incident, and contact information. In this example though, the insured or claim adjuster may have provided notes about the insurance claim, such as “it looks like black mold,” “the bumper broke off which appeared to cause my trunk flap to flip up and break my back window,” “the Pool Company X installed the pool that caused the flood in my basement,” “the roof shingles were damaged due to the storm,” and or “the basement flooded due to heavy rains.” The notes (e.g., unstructured data items) would be isolated to the particular protection record. However, other protection records may have similar notes, such as “it looks like a dark mold,” “the bumper broke off and caused my back window to break due to trunk flipping up,” “the Pool Company X installed the pool that leaked into my basement,” “the roof shingles were torn off by high winds,” and or “the basement water damage was due to a sump pump failure.” In these examples, notes across users, entities, third parties, etc. may be modeled to identify common issues or trends. That is, the isolated unstructured notes may be used to improve the accuracy of predictive models.

As used herein, “unstructured data” may refer to both data not conforming to a predetermined form and/or substance, and data conforming to a plurality of different forms and/or substances. This includes data that may not be converted or normalized into a specific form or substance for ingestion by the model. Unstructured data may include various formats such as text, images, videos, and sensor data. Unstructured data may also include any data that is inherently diverse in its formatting and content.

For instance, the unstructured data items may include claim adjuster notes regarding a particular house X. In this example, Claim Adjuster John Doe may have entered notes about House X and stated “house X was built by builder Z.” In this example, Claim Adjuster Jane Doe may have entered notes about particular house Y and stated “house Y was built by builder Z.” The modeling system 110 may model the unstructured data items including the claim notes to identify trends associated with builder Z. That is, the modeling system 110 may determine if houses built by builder Z are more prone to certain types of claims. In another example, the unstructured data items may include mechanic notes regarding a particular car. In this example, Mechanic John Doe (e.g., in State A) may have entered notes about Car X and stated, “Car X shows signs of transmission issues.” In this example, Mechanic Jane Doe (e.g., in State B) may have entered notes about Car X and stated, “Car X has frequent transmission failures.” That is, the modeling system 110 may determine if Car X is more prone to transmission issues.

The modeling system 110 may model the unstructured data items to identify recurring issues that may impact underwriting decisions, decrease advertisements, change in policy language, or adjust other protection parameters. As shown, unstructured data items from various sources may be modeled to identify trends and facilitate updates (e.g., to protection parameters, inform suppliers, or companies of a defective product, etc.).

In some embodiments, the data interface 115 may be configured to receive a plurality of unstructured data items associated with a plurality of protection records. Generally, “unstructured data items” refers to non-relational data generated by a plurality of sources. For example, the unstructured data items may be, without limitations, insurance claim notes (e.g., provided by an insured, provided by a claim handler), call recordings, images of damage, videos of incidents, or any other protection data. That is, the unstructured data items originate from multiple data sources and/or channels.

In some implementations, the unstructured data items may be generally associated with or correspond to data collected and/or stored by an entity, for instance entity computing system 150. The entity may be, without limitations, an insurer, a protection entity, a claims processing center, an underwriter, an assessment firm, or any other related organization. In some implementations, structured data of the entity may be, without limitations, policy details, protection parameters, claim histories, or customer information. In various embodiments, the technical improvements and solution described herein use unstructured data items to improve prediction accuracy and pattern recognition. Oftentimes unstructured data items vary in scope, context, and details. However, the technical improvement provided by various implementations is to extract insights and actionable updates to protection parameters.

In various implementations, the plurality of protection records may correspond to at least one protection product. The at least one protection product may be one or more policies (and/or endorsements) that may include at least one of a homeowner policy, a life policy, an automotive policy, renters' policy, a personal articles policy, a parametric policy, various or related endorsements, or a health policy. For example, the protection records may be, without limitations, insurance claims, policyholder reports, inspection reports, customer service interactions, or any other related documentation. In another example, the protection products may be, without limitations, insurance products, extended warranties, service contracts, mitigation services, or any other related offerings. That is, the unstructured data items may include various forms of documentation and media associated with these products.

In various embodiments, the entity computing system 150 may generate and store the unstructured data items, protection record data, and protection product data in the protection product dataset 122. For instance, the data interface 115 may query or otherwise access the protection product dataset 122 of the protection database 120 to retrieve information for analysis. In some implementations, the entity computing system 150 may provide a data feed (e.g., real-time, near real-time, periodic, accessible) to the modeling system 110 such that the unstructured data items (e.g., unstructured multimedia data, unstructured notes, etc.) may be monitored and analyzed. That is, instead of accessing the protection product dataset 122 for some or all of the unstructured data items, the data interface 115 may directly interface with the data feed. For example, the data interface 115 may process incoming data in real-time to update protection parameters dynamically.

In some implementations, the one or more protection products may include at least one of: (i) a homeowner policy, (ii) a life policy, (iii) an automotive policy, (iv) a health policy, and (v) personal articles policy (and/or related endorsements). In some implementations, information relating to the one or more protection products may include at least one of: (i) an address of a building, (ii) a size of the building, (iii) an age of the building, (iv) a make and model of a vehicle, (v) a vehicle identification number, (vi) previous claims filed for the one or more protection policies, and/or (vii) coverage of the one or more protection products for one or more events.

In some embodiments, the data interface 115 may be configured to monitor, using at least one data feed, multimedia data of at least one protection record of the plurality of protection records. For instance, the multimedia data may be, without limitations, call records, videos, images, social media posts, emails, or any other digital media. The monitoring may occur in real-time, near real-time, or periodically.

That is, real-time monitoring of a phone call may include transcribing (e.g., audio-to-text, video-to-text) the conversation into data items (e.g., notes or other unstructured data types described herein) and the modeling system 110 may analyze the content for relevant information. For example, when a claim handler conducts a phone conversation with an insured, the data interface 115 may automatically capture and transcribe the audio data to extract unstructured data items. In some implementations, monitoring may be periodic such that the data interface 115 may access the protection product dataset 122 for recordings, videos, images, and/or other multimedia data. For instance, a plurality of videos of a plurality of protection records (e.g., insurance claims) may be saved in the protection product dataset 122.

In various implementations, the data interface 115 may be configured to convert the multimedia data into the plurality of unstructured data items of the at least one protection record. That is, converting may include transcribing audio data, transcribing video data, extracting text from images, or any suitable transformation process. For example, the multimedia data may be converted into text files, metadata, or structured logs (e.g., but unstructured in the content of the files, metadata, or logs). In another example, the data interface 115 converts the multimedia data into a standardized format for input into the prompt system 116 and modeler 117. In some implementations, the data interface 115 may convert the multimedia data in real-time to facilitate immediate analysis. For instance, as multimedia data is received, the data interface 115 may convert it and feed it into the AI models for analysis and response.

In certain embodiments, the prompt system 116 may be configured to generate a prompt based upon the plurality of unstructured data items for one or more artificial intelligence (AI) models. That is, generating the prompt may include extracting one or more associations corresponding to contextual information and attribute information of the plurality of unstructured data items. The associations may be categories or correlations between information of the unstructured data items. For example, the contextual information may be notes of the circumstances, environment, and/or conditions surrounding the protection records. In another example, attribute information may be notes of the specific details, characteristics, and properties of the protection records themselves.

In various embodiments, the associations extracted from the plurality of unstructured data items includes identifying correlations between the plurality of unstructured data items of the plurality of protection records. For instance, the prompt system 116 may determine patterns in claim submission times, types of reported damages, or recurring customer issues. In another example, the prompt system 116 may determine correlations between environmental conditions and claim frequency. The contextual information may correspond to circumstantial factors and environmental factors of each of the plurality of protection records.

In some embodiments, circumstantial factors may be time of incident, location, or any other situational details. In various implementations, environmental factors may be weather conditions, socio-economic conditions, or any other external influences. Additionally, attribute information may correspond to attributes and properties of each of the plurality of protection records. In some implementations, attribute information may be type of claim, severity of damage, or any other specific details. For example, attribute information may include the make and model of a damaged item or the specific nature of a reported injury.

In certain embodiments, extracting the associations by the prompt system 116 may include analyzing unstructured data items for common themes and patterns. That is, extraction may include the prompt system 116 identifying relationships and trends within the data. For instance, extraction may include parsing text for keywords and phrases indicative of claim types. In another example, extraction may include using natural language processing to interpret context and sentiment from claim notes. In various embodiments, associations may be categories of incidents, types of damages, or recurring issues. That is, the prompt system 116 may link related data points to generate a prompt to facilitate modeling by modeler 117.

For example, categories may be weather-related claims, theft-related claims, or accidental damage claims. In this example, the contextual information associations of the unstructured claim notes, multimedia, or other data may be used to understand the circumstances of claims. Additionally, in this example, the attribute information associations of the unstructured claim notes, multimedia, or other data may be used by the prompt system 116 to detail specific claim characteristics. In another example, correlations may be drawn by the prompt system 116 between geographic locations and claim frequencies. In this example, the contextual information associations of the unstructured claim notes, multimedia, or other data may be analyzed by the prompt system 116 for environmental factors. Additionally, in this example, the attribute information associations of the unstructured claim notes, multimedia, or other data may be analyzed by the prompt system 116 for specific attributes like claim amount and type of damage. In some embodiments, the extraction of the associations may be used to generate the prompts by the prompt system 116. The prompts may be structured to identify data points to facilitate AI model analysis.

In various implementations, generation of the prompt may include the prompt system 116 compiling the extracted associations into a query for the AI models. That is, the prompts may be used as input, with the unstructured data items, to one or more AI models of modeler 117. For instance, the prompt system 116 may generate a prompt to ask the AI model to identify trends in theft-related claims during holiday seasons. In another example, the prompt system 116 may generate a prompt to analyze the impact of severe weather on home insurance claims.

In some implementations, prompts may be detailed questions or commands. That is, the prompts may direct the AI models to focus and/or emphasize on specific aspects of the unstructured data items. For example, a prompt may be “Identify the correlation between location and frequency of fire-related claims.” In this example, the prompt may provide the one or more AI models with targeted data for analysis. For instance, a prompt may be “Analyze patterns in customer complaints related to delayed claim processing.” In this example, the prompt may provide the one or more AI models with specific parameters to investigate and report on.

In some embodiments, the modeler 117 may be configured to apply the plurality of unstructured data items and the prompt as input to the one or more AI models. Applying the plurality of unstructured data items and the prompt as the input to the one or more AI models may include transforming the plurality of unstructured data items and prompt into a plurality of feature vectors. For example, the feature vectors may be numerical representations of data attributes extracted from the unstructured data items. For instance, the text “water damage in basement” may be transformed into a feature vector [0.2, 0.8, 0.5] where each number represents a different attribute. In this example, 0.2 may correspond to the severity of damage, 0.8 may correspond to the likelihood of mold growth, and 0.5 may correspond to the estimated repair cost. That is, transforming may include the modeler 117 converting textual and multimedia data into structured numerical data.

In various embodiments, applying the plurality of unstructured data items and the prompt as the input to the one or more AI models may include normalizing the plurality of feature vectors to a scale. For example, the scale may be a range from 0 to 1 or standard deviation units. That is, normalizing may include the modeler 117 adjusting the data to a common scale to facilitate consistent input for the AI models. In various implementations, applying the plurality of unstructured data items and the prompt as the input to the one or more AI models may include the modeler 117 processing the normalized plurality of feature vectors using the one or more AI models to perform predictive and pattern recognition to cause the one or more AI models to generate the output.

That is, performing predictive and pattern recognition on the input (e.g., unstructured data items and the prompt) may include the modeler 117 analyzing the data for trends, anomalies, and future events. In certain embodiments, the AI model may be a neural network, decision tree, support vector machine, or any other analytical model. In some implementations, the AI model of the modeler 117 may process the claim notes and the identified associations to identify potential future claim events, trends, or patterns. For instance, the AI model may be a generative AI model. For example, processing the unstructured data items and the prompt may include the modeler 117 identifying recurring keywords and patterns that suggest a trend.

Applying the unstructured data items and the prompt as input may cause the one or more AI models of the modeler 117 to generate an output regarding at least one of an occurrence prediction or a pattern identification within the plurality of unstructured data items. For instance, the output may correspond to a determination of future claim events or trends. In another example, the output may correspond to a detection of recurring claim events or trends. That is, the output may include an update to at least one protection parameter of the at least one protection product. For example, the update may be an enhancement to one or more underwriting rules, policy criteria, settings, or the like in a protection product.

Generally, protection parameters may be underwriting rules, policy limits, deductible amounts, risk assessment criteria, eligibility requirements, claim settlement procedures, loss prevention measures, coverage exclusions, renewal policies, fraud detection mechanisms, customer service protocols, data privacy standards, reporting requirements, compliance guidelines, operational workflows, coverage terms, and/or any other relevant parameter that influences the configuration and management of protection products. In various implementations, the update by the modeler 117 to the at least one protection parameter may be an update to a deductible parameter for at least one future protection product. For instance, the modeler 117 may adjust the deductible for high-risk areas based upon modeling. In another example, the modeler 117 may update a coverage parameter for the at least one future protection product. For instance, the modeler 117 may expand coverage options for regions frequently affected by natural disasters.

In various embodiments, the update to the at least one protection parameter may be an update to a product exclusion parameter for the at least one future protection product. For example, the modeler 117 may determine a coverage exclusion for specific high-risk activities identified through pattern analysis.

In various implementations, the update to the at least one protection parameter may be an update to a processing protocol parameter for the at least one future protection product. For instance, the modeler 117 may implement faster claim processing protocols for common types of claims. In some implementations, the update to the at least one protection parameter may be an update to a new query for the at least one future protection product. For instance, the modeler 117 may generate new queries to refine assessment or protection models based upon recent claim data.

As discussed herein, the modeler 117 may utilize machine learning, generative artificial intelligence, or other advanced computing techniques. In certain embodiments, generative artificial intelligence (GenAI or GAI) models (also referred to as generative machine learning (ML) models) and/or other AI/ML models discussed herein may be implemented via and/or coupled to the modeler 117. That is, the modeler 117 may be configured to implement machine learning, facilitating the learning and adapting of the modeling system 110 operations without being explicitly programmed. Machine learning and artificial intelligence may be implemented using a variety of methods and algorithms. In one exemplary embodiment, a machine learning module or circuit within modeler 117 may be configured to implement these ML methods and algorithms to continuously improve prediction accuracy and pattern recognition capabilities.

In various embodiments, the GenAI or GAI models may be transformer-based models, LLM-based models, recurrent neural networks (RNNs), or any suitable AI/ML models. For instance, the GenAI model may be a transformer-based model that uses self-attention mechanisms to analyze sequential data. The transformer-based model may include multiple layers of attention heads and feed-forward networks. In another instance, the GenAI model may be an LLM-based model that uses large-scale datasets to extract patterns and generate predictions. Generally, the GenAI models may process the unstructured data items by identifying contextual relationships, extracting relevant features, and generating outputs based upon learned patterns.

In various implementations, an AI model may be trained by the modeler 117 by using historical claim data (e.g., stored in protection product dataset 122) to learn patterns and make predictions. That is, training may include feeding the model datasets of past claims to identify trends and correlations. For example, a GenAI model may be trained by using labeled data of past insurance claims categorized by type, cause, and outcome. In this example, after training, the GenAI model may be implemented by the modeler 117 to generate outputs regarding at least one of an occurrence prediction or a pattern identification within the plurality of unstructured data items. The GenAI model may be used by the modeler 117 to identify emerging risks and suggest proactive adjustments to protection parameters.

In some embodiments, the modeler 117 may access and utilize multiple types of databases during both training and implementation phases to correlate and generate data pairs for analysis. For example, during training, the modeler 117 may aggregate data from different sources, such as first notice of loss (FNOL) information from one database and resolution outcomes or other related data from another, to cross-correlate these data points. In this example, the AI models may be trained to identify patterns and correlations between FNOL timing and claim outcomes, which can then be applied during implementation. During implementation, the modeler 117 may dynamically process and correlate incoming data on the fly, using similar data sources to generate predictions and adjust protection parameters in real time based on the latest available information.

In some embodiments, GenAI model may be a supervised learning model trained on labeled protection records of the plurality of protection records. That is, the supervised learning model may be trained by the modeler 117 using datasets where outcomes are known and used to guide learning. For instance, historical claims labeled as fraudulent or non-fraudulent may be used to train the model to detect fraud. In some implementations, GenAI model may be an unsupervised learning model trained on unlabeled protection records of the plurality of protection records. That is, the unsupervised learning model may be trained by the modeler 117 using data without predefined categories to identify hidden patterns. For instance, analyzing claim data without labels to identify new and unexpected trends. Once trained, the GenAI may be implemented by the modeler 117 to monitor and analyze new unstructured data items to provide outputs.

In certain embodiments, the supervised learning model and/or the unsupervised learning model may include an association detector to assign the probability metric of the occurrence prediction. The association detector may be executable code or a data package that the modeler 117 uses to analyze patterns in the protection records. The association detector may be used by the learning model during training by the modeler 117 or during implementation to identify relationships between various data points. That is, the association detector may be used by the modeler 117 in predicting the likelihood of future events based upon historical data. For example, assigning the probability metric of the occurrence prediction may include the modeler 117 calculating the likelihood of a certain type of claim occurring based upon past data trends.

In various embodiments, the supervised learning model and/or the unsupervised learning model may include a pattern tracker used by the modeler 117 to assign the frequency metric of the pattern identification. The pattern tracker may be executable code or a data package that the modeler 117 uses to monitor recurring events within the data. The pattern tracker may be used by the learning model during training by the modeler 117 or during implementation to track the occurrence of patterns over time. That is, the pattern tracker may be used by the modeler 117 in identifying how frequently certain events happen. For instance, assigning the frequency metric of the pattern identification may include the modeler 117 determining how often a specific type of claim reoccurs within a given period.

In various implementations, the modeler 117 may facilitate reinforcement learning of the one or more models (e.g., AI model, GenAI model, etc.). Reinforcement learning may include updating the GenAI model based upon receiving feedback on the output and the at least one action from a reward signal generated from performance metrics of the plurality of protection records. In some embodiments, the feedback may be of the output and the at least one action determined. The reward signal may be a quantitative measure of the model's performance. For instance, the reward signal may be based upon metrics such as achieving a 20% reduction in the number of fraudulent claims detected or increasing the accuracy of predicting future claim occurrences by 15%.

Generating the reward signal from the performance metrics may include the modeler 117 determining the accuracy and effectiveness of the model's predictions. That is, the modeler 117 may improve the AI models by incorporating real-time feedback. For example, a performance metric may be the accuracy of claim predictions, and the reward signal may be generated by the modeler 117 to compare predicted outcomes to actual claim results. As shown, the feedback on the output may be used to refine the AI model. The modeler 117 may use the feedback to perform reinforcement learning on a model by adjusting its parameters based upon the reward signal. For instance, the modeler 117 may increase the weight of certain variables of models that lead to more accurate predictions.

In another example, feedback on the output may be received from an entity computing system 150. In this example, a claim handler or another individual of the entity computing system 150 may interact with the modeler 117 implementing a GenAI model (e.g., a prompt element to be displayed—an input/output device 155) by providing feedback on the model's recommendations. The interaction with the prompt element may be received by the modeler 117 to update the model based upon insights. The modeler 117 may use the feedback (e.g., the interaction, such as accepting or rejecting a recommendation) to perform reinforcement learning on a model by refining its decision-making process. For instance, if a claim handler consistently overrides a specific recommendation, the modeler 117 may train the model to adjust outputs to align better with human judgment.

In yet another example, feedback on the output may be received from a user computing system 140. In this example, an insured or another individual of the user computing system 140 may interact with the modeler 117 implementing a GenAI model (e.g., a prompt element to be displayed—an input/output device 145) by providing feedback on the claim processing experience. The interaction with the prompt element may be received by the modeler 117 to improve the model's user-centric features. The modeler 117 may use the feedback (e.g., the interaction, such as satisfaction ratings or comments) to perform reinforcement learning on a model by enhancing its responsiveness to user needs. For example, if users frequently report difficulties with a particular claim submission process, the modeler 117 may train the model to simplify the outputs.

In some implementations, the protection system 118 may be configured to determine at least one action to apply the update to the at least one protection parameter of the at least one protection product. The action may be the implementation of a change to the underwriting rules, policy criteria, settings, etc. That is, the at least one action may include a response to the plurality of unstructured data items and the prompt. The response may cause a tuning of a probability metric of the occurrence prediction or a tuning of a frequency metric of the pattern identification.

In some embodiments, the response may address the trend(s) and/or pattern(s) identified in the unstructured data items of the protection records. For instance, tuning of the probability metric of the occurrence prediction may correspond to a determined action that minimizes potential future losses through proactive measures and optimized pricing strategies. In another example, tuning of the frequency metric may correspond to a determined action that remediates a recurring protection record, e.g., by changing underwriting requirements, changing marketing of the protection product, etc.

In certain embodiments, the response causing the protection system 118 to tune the probability metric may include reducing the probability metric corresponding with reducing a probability of a future protection record. That is, the response to the unstructured data items and prompt modeling may include the protection system 118 performing an action that would reduce a probability of a future claim or reduce losses associated with a future claim (e.g., a probability metric).

In various embodiments, a probability metric may be, without limitation, a risk score, likelihood of occurrence, chance of default, or any similar measure. For example, the probability metric may be calculated based upon historical data trends and current risk factors. In this example, the probability metric prior to modeling may be 0.75, but the probability metric after determining and/or performing the action by the protection system 118 may be reduced to 0.50. Thus, the probability metric may be tuned by the protection system 118 based upon performing the action. As shown, tuning the probability metric refers to the process of adjusting assessments to better manage and mitigate potential future claims.

In various implementations, the response causing the tuning of the frequency metric of the pattern identification by the protection system 118 may include updating the frequency metric corresponding with a persistence probability of a subset of the plurality of protection records. That is, the response to the unstructured data items and prompt modeling may include the protection system 118 performing an action that would update a persistence probability of a subset of the plurality of protection records (e.g., a frequency metric).

In certain embodiments, a frequency metric may be, without limitation, recurrence rate, incident frequency, trend stability, or any similar measure. For instance, the frequency metric may be calculated by analyzing a plurality of similar claim notes (e.g., black mold, particular car brand, general location) over a given period. In this example, the frequency metric prior to modeling may be a high recurrence rate, but the frequency metric after determining and/or performing the action by the protection system 118 may be reduced. Thus, the frequency metric may be tuned by the protection system 118 based upon performing the action. As shown, tuning the frequency metric by the protection system 118 refers to the process of modifying trend analysis to better understand and address recurring claim patterns.

In some implementations, the protection system 118 may determine additional data to apply as the input to the one or more AI models responsive to the generation of the output regarding at least one of the occurrence prediction or the pattern identification within the plurality of protection records. That is, the additional data may be determined by the protection system 118 by analyzing existing outputs and identifying gaps or areas needing further information. For example, the additional data may be additional unstructured data items related to recent claim submissions in a specific geographic region. In another example, the additional data may be additional unstructured data items related to the frequency of certain types of claims, such as water damage or theft.

In some embodiments, the protection system 118 may request, from at least one data feed (e.g., the user computing system 140, entity computing system 150, and/or protection database 120), additional data corresponding to the plurality of protection records. For instance, the protection system 118 may generate and provide a request to the user computing system 140 that seeks detailed incident reports or customer feedback. In another example, the protection system 118 may generate and provide a request to the entity computing system 150 that asks for updated contractor reports or repair estimates.

In various embodiments, the protection system 118 may access, from at least one data feed (e.g., the user computing system 140, entity computing system 150, and/or protection database 120), additional data corresponding to the plurality of protection records. For example, the protection system 118 may access the protection product dataset 122 to retrieve historical claim data for trend analysis. In another example, the protection system 118 may access the entity computing system 150 to obtain recent inspection reports or adjuster notes.

In various implementations, the modeler 117 may be configured to cause a user interface to display the output, including a prompt element for receiving user input. That is, the prompt element may be an interactive field or button that allows users to provide additional information or feedback. For instance, the prompt element may be a text box where users may enter specific details about a claim. In certain embodiments, the user interface may be a web-based application or a mobile app interface. For example, a user interface displayed on the user computing system 140 may be a dashboard showing the status of claims and prompts for additional information. In this example, an insured may interact with the prompt element of the modeler 117 by uploading photos of the damage or providing a description of the incident. In another example, a user interface displayed on the entity computing system 150 may be a claims management portal. In this example, a claim handler may interact with the prompt element of the modeler 117 by entering notes from a recent inspection or updating the status of a claim.

In some implementations, the modeler 117 may be configured to generate a query according to the at least one action. The query may be generated during an active session between a plurality of users. For instance, the active session may be an active session with a GenAI application or a collaborative workspace. That is, during an active session between a plurality of users, the active session may include an active connection between a first computing system of a first user and a second computing system of a second user. In various implementations, the first user and/or the second user may be digital users, chatbots, or GenAI interfaces that may facilitate interaction and data exchange. For example, the active connection may be between a claim handler operating the entity computing system 150 and the modeling system 110 such that the modeler 117 of the modeling system 110 may provide real-time updates and recommendations. In another example, the active connection may be between an insured operating the user computing system 140 and the modeling system 110 such that the modeler 117 of the modeling system 110 may guide the user through data submission processes, claim processes, renewal processes.

In various embodiments, the modeler 117 may be configured to cause a user interface to display the query to at least the first computing system or the second computing system. That is, the query may prompt users for specific actions or information to improve the model's accuracy. For instance, the query by the modeler 117 may ask the claim handler to verify the details of one or more claims or request additional documentation from the insured. In another example, the query by the modeler 117 may prompt the insured to provide further details about the incident.

In certain embodiments, the protection database 120 may be configured to store and organize data used in modeling by the modeling system 110. The data may include the protection product dataset 122 and the protection parameter dataset 124. The protection product dataset 122 may contain records of various protection products, including historical claims, policy details, unstructured data items, and related documentation. The protection parameter dataset 124 may store information on different protection parameters, such as underwriting criteria, and coverage limits.

The data stored in these datasets may be accessed and processed by the modeling system 110 to perform modeling and generate actions. For example, the modeling system 110 may retrieve data from the protection product dataset 122 to identify trends in unstructured data items or analyze the performance of specific insurance products. Additionally, the protection parameter dataset 124 may be updated by the modeling system 110. In some embodiments, the entity computing system 150 and/or user computing system 140 may access and provide data to the protection database 120. For instance, unstructured data items regarding particular claims may be provided by the entity computing system 150 and/or user computing system 140 and stored in the protection product dataset 122.

Referring still to FIG. 1, according to some embodiments, the modeling system 110 is configured to communicate with components of the analytics system 100. For example, protection record information, protection product information, and/or data associated with the user computing system 140 and/or the entity computing system 150 may be communicated to the modeling system 110 (e.g., via the network 130). Information and/or data associated with the protection database 120 may also be communicated to the modeling system 110 (e.g., via the network 130).

In some implementations, the modeling system 110 is implemented using cloud computing services. In various implementations, the modeling system 110 is implemented using one or more computing devices, for instance, operating alone and/or in combination. In various embodiments, the modeling system 110 is implemented using computing architectures like multiple distributed servers, and/or similar computing devices and/or systems.

In certain embodiments, the modeling system 110 is another suitable computing system, for example, distributed across multiple systems or devices (e.g., which may be located within a single building or facility, or distributed across multiple different buildings or facilities), or within a single computer (e.g., one server, housing, etc.). All such implementations are contemplated herein. The modeling system 110 may be a virtual reality (VR) system or augmented reality (AR) system, for example to provide digital connections between a plurality of metadata sources, where the metadata sources are integrated within the VR system or AR system. The modeling system 110 may include one or more local or remote processors, servers, transceivers, sensors, memory units, mobile devices, wearables, smart watches, smart rings, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another.

As shown, the modeling system 110 may be configured to communicate with the user computing system 140. In various implementations, the user computing system 140 may include one or more processing circuits 142, including processor(s) 143 and memory 144. The memory 144 may have instructions stored thereon that, when executed by processor(s) 143, cause the one or more processing circuits 142 to perform the various operations described herein. The operations described herein may be implemented using software, hardware, or a combination thereof. The processor(s) 143 may include a microprocessor, ASIC, FPGA, etc., or combinations thereof. In many implementations, processor(s) 143 may be a multi-core processor or an array of processors. Memory 144 may include, but is not limited to, electronic, optical, magnetic, or any other storage devices capable of providing processor(s) with program instructions. The instructions may include code from any suitable computer programming language.

In some implementations, the user computing system 140 may be used for submitting claims, communicating with the entity computing system 150 (e.g., claim handler), and/or interacting with the GenAI outputs and providing feedback to the modeling system 110. For instance, the user computing system 140 may transmit data such as text, images, and videos related to claims (e.g., in an unstructured format). The user computing system 140 may also receive updates and feedback from the entity computing system 150 regarding the status of claims or events. The user computing system 140 may perform preliminary validation of the data before transmission. In certain embodiments, the user computing system 140 may execute algorithms to preprocess the data, such as noise reduction in images or transcription of voice recordings.

Additionally, the user computing system 140 may interact with other systems to gather necessary data, such as accessing protection database 120 to retrieve historical claim information (e.g., stored in protection product dataset 122). The user computing system 140 may facilitate communication (e.g., over network 130) between the insured, the entity computing system 150, and the modeling system 110. Various protocols and data formats may be supported to provide compatibility and integration with other systems of analytics system 100.

In certain embodiments, the user computing system 140 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein. The user computing system 140 may include one or more local or remote processors, servers, transceivers, sensors, memory units, mobile devices, wearables, smart watches, smart rings, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another.

In various embodiments, the input/output device 145 may be configured to facilitate data entry and communication (e.g., entry of unstructured data items, such as claim notes). For example, the input/output device 145 may be used to input claim details, capture images or videos, and display feedback from the modeling system 110. The input/output device 145 may include various peripherals such as keyboards, touchscreens, virtual reality headsets, augmented reality headsets, sensors, scanners, displays, and cameras. These peripherals support precise and detailed data entry. The input/output device 145 may also provide real-time prompts and guidance to the user.

Additionally, the input/output device 145 may support multiple modes of interaction, such as manual data entry and automated data capture. The input/output device 145 may also display status updates and notifications, keeping the user (e.g., adjuster, claim handler, etc.) informed throughout the claim process or about trends from unstructured data items of the plurality of users (e.g., of the entity). Furthermore, the input/output device 145 may be integrated with other systems of analytics system 100 for data exchange. The input/output device 145 may facilitate communication (e.g., over network 130) between various users or computing systems involved in the claim process and/or unstructured data items analysis, including the insurer, claim handlers, adjusters, third parties (e.g., car repair shops, roof repair companies, general contractors) and the modeling system 110. Various interfaces and communication protocols may be used to achieve this integration.

Additionally, the modeling system 110 may be configured to communicate with the entity computing system 150. In certain embodiments, the entity computing system 150 may include one or more processing circuits 152, including processor(s) 153 and memory 154. The memory 154 may have instructions stored thereon that, when executed by processor(s) 153, cause the one or more processing circuits 152 to perform the various operations described herein. The operations described herein may be implemented using software, hardware, or a combination thereof. The processor(s) 153 may include a microprocessor, ASIC, FPGA, etc., or combinations thereof. In many implementations, processor(s) 153 may be a multi-core processor or an array of processors. Memory 154 may include, but is not limited to, electronic, optical, magnetic, or any other storage devices capable of providing processor(s) with program instructions. The instructions may include code from any suitable computer programming language.

In various implementations, the entity computing system 150 may manage communication with the user computing system 140 and/or the modeling system 110 and storage in protection database 120. For instance, the entity computing system 150 may receive claims submitted by users, validate the information, provide notes, and communicate with the modeling system 110 for further analysis. The entity computing system 150 may receive various types of unstructured data items, including claim notes, images, videos, and other information related to claims. Claim notes may include detailed descriptions of the incident, statements from involved parties, and notes from claim handlers. Images and videos may provide visual evidence of damage or loss. The entity computing system 150 may store this unstructured data items in the protection product dataset 122 of the protection database 120 for retrieval and processing (e.g., by modeling system 110).

Additionally, the entity computing system 150 may facilitate communication with external databases and services to obtain claim information and gather additional data, such as weather reports for claims related to natural disasters or police reports for theft claims. The entity computing system 150 may also generate reports and summaries based upon the data analyzed by the modeling system 110, which may be used for updating protection products and/or parameters and external communication with policyholders or other third parties. Various protocols and data formats may be supported to provide compatibility and integration with other systems of analytics system 100.

In certain embodiments, the entity computing system 150 may be another suitable computing system, for example distributed across multiple systems or devices (e.g., which may be located within a single building or facility, or distributed across multiple different buildings or facilities), or within a single computer (e.g., one server, housing, etc.). All such implementations are contemplated herein. The entity computing system 150 may include one or more local or remote processors, servers, transceivers, sensors, memory units, mobile devices, wearables, smart watches, smart rings, smart contact lenses, smart glasses, augmented reality glasses, virtual reality headsets, mixed or extended reality glasses or headsets, voice bots, chatbots, ChatGPT bots, InstructGPT bots, Codex bots, Google Bard bots, and/or other electronic or electrical components, which may be in wired or wireless communication with one another.

In some implementations, the input/output device 155 may be configured to facilitate data entry, communication, and feedback. For example, the input/output device 155 may be used by claim handlers to input claim details, notes from calls with the insured, capture images or videos, and view feedback from the modeling system 110. The input/output device 155 may include various peripherals such as keyboards, touchscreens, virtual reality headsets, augmented reality headsets, sensors, scanners, displays, and cameras. The keyboards, touchscreens, virtual reality headsets, augmented reality headsets, sensors, displays, and cameras may also provide real-time prompts and guidance to claim handlers.

Additionally, the input/output device 155 may support multiple modes of interaction, such as manual data entry and automated data capture. The keyboards, touchscreens, virtual reality headsets, augmented reality headsets, sensors, displays, and cameras may display status updates and notifications, keeping claim handlers informed about trends and/or the claim process. Furthermore, the input/output device 155 may be integrated with other systems of analytics system 100 for data exchange. The input/output device 155 may facilitate communication (e.g., over network 130) between various users or computing systems involved in the claim process and/or unstructured data items analysis, including the insured, claim handlers, adjusters, third parties (e.g., car repair shops, roof repair companies, general contractors) and the modeling system 110. Various interfaces and communication protocols may be used to achieve this integration.

The modeling system 110 may also be configured to identify trends in insurance costs that may support an insurance filing for rate optimization by analyzing unstructured data items. For instance, Large Language Models and supporting processes may be utilized by the modeling system 110 to identify trends from summarizing social media posts, industry articles, and legal documents. This unstructured data items may be used by the modeling system 110 to determine early identification of cost trends, such as trends in jury awards or arguments affecting payouts (social inflation), anticipated trends in parts and labor availability and costs not fully reflected in industry data, changes in societal expectations of insurance coverage, and trends in driving behavior, such as during the pandemic. By processing this unstructured data items, the modeling system 110 may generate updates to protection parameters related to rate adequacy filings.

The modeling system 110 may also be configured to improve customer options and benefits by segmenting and matching prices to risk by modeling unstructured data items, as opposed to determining overall rate adequacy. The modeling system 110 may identify new data sources providing additional insights or new uses for existing data sources. For example, the modeling system 110 may use GenAI to identify causal interactions between disparate data sources, utilizing these interactions to segment the insured population more effectively for accurate rate matching. That is, the segmentation can be used to lower costs for lower-risk segments or reward beneficial activities. Examples include the modeling system 110 using GenAI to summarize competitor rate filings, social media discussions of dangerous intersections or routes, which may feed into geographic-based rating or telematics models, and external data to speed the review of information feeding into segmentation models, such as trends in public records. By processing this unstructured data items, the modeling system 110 may generate updates to segmentation-related protection parameters.

The modeling system 110 may also be configured to identify underserved markets and additional opportunities for products by analyzing unstructured data items from social, broadcast, and print media. By detecting underserved markets, the modeling system 110 may target them appropriately with product innovation, pricing differentiation, and marketing. For instance, the modeling system 110 may analyze unstructured data items to identify regions or demographics that lack adequate protection products or have specific needs not currently met by existing products. By processing this unstructured data items, the modeling system 110 may generate updates to protection parameters related to market targeting and product offerings.

The modeling system 110 may also be configured to customize call scripts in real-time by analyzing unstructured data items from monitored calls to enhance communications and reduce unintended bias. For example, regional and cultural vocabulary choices, social norms for communication, and dialects may vary and be sources of miscommunication. The modeling system 110 may monitor calls in real-time using AI to identify relevant attributes and pass them to a GenAI to customize call scripts. By processing this unstructured data items, the modeling system 110 may generate updates to protection parameters related to customer interaction protocols.

The modeling system 110 may also be configured to collect natural language input from users, modify the code used to create standard reports, execute the code, and present the modified reports to actuaries. The modeling system 110 implementing GenAI may facilitate this process interactively. For instance, an actuary may input specific queries or modifications, and the modeling system 110 may generate the required variations of the report, ensuring that the reports are customized to the specific needs and requirements. By processing this unstructured data items, the modeling system 110 may generate updates to protection parameters related to reporting and regulatory compliance.

The modeling system 110 may also be configured to update rate filing wording to adjust the tone or assist with large rate filings, making them acceptable to regulators by analyzing unstructured data items. For example, language may be present throughout a filing referencing changes to loss frequency due to the pandemic. The modeling system 110 may also review for clarity and consistency and more abstract concepts like politeness, helping an actuary draft an initial filing or review language. By processing this unstructured data items, the modeling system 110 may generate updates to protection parameters related to documentation and regulatory submissions.

The modeling system 110 may also be configured to utilize semantic search of documents and GenAI to provide real-time responses to actuaries responding to inquiries from executives and others regarding rate filings. Responses may be based upon individual filings or groups of rate filings with specific characteristics. The modeling system 110 may provide information on specific filings identified for confirmation and additional commentary. By processing this unstructured data items, the modeling system 110 may generate updates to protection parameters related to inquiry handling and information dissemination.

The modeling system 110 may also be configured to adapt existing rate filings or documents to new jurisdictions by analyzing unstructured data items. In actuarial filings, it is common to have many slightly different versions based upon jurisdiction, such as rates by county in Illinois or Parish in Louisiana. The modeling system 110 may receive or identify, as input to GenAI model, existing rate filing or document and adapt it to a new jurisdiction. This may also occur to draft other policy documents. For instance, if there is a Texas homeowners' policy that needs to be rewritten for Idaho, complying with Idaho law, the modeling system 110 may reference Idaho law and/or competitor filings to create a compliant document. By processing this unstructured data items, the modeling system 110 may generate updates to protection parameters related to jurisdictional compliance and document adaptation.

Referring still to FIG. 1, according to some embodiments, the modeling system 110, particularly modeler 117, may be configured to receive (or collect) historical claim data from at least one of one or more sensors or one or more databases. For example, the historical claim data may correspond to insurance claims data. In another example, the historical claim data may include records of past insurance claims sourced from various sensors and databases (e.g., customer reports, sensor data, third-party information). That is, the data interface 115 may aggregate and standardize this information for subsequent analysis by the modeler 117. Additionally, the collected data may be stored in protection product dataset 122 for retrieval and use.

In some implementations, the modeler 117 may be configured to input the historical claim data into a trained generative AI or machine learning model to identify at least one of (i) one or more baseline claims or (ii) one or more emerging trends in claims of the historical claim data. For instance, the trained generative AI or machine learning model may be trained using a dataset comprising labeled historical insurance claims from a plurality of data sources (e.g., customer reports, sensor data, third-party information). That is, identifying the one or more baseline claims may include modeling historical claim patterns, frequencies, and characteristics to generate a reference model. Additionally, the one or more baseline claims may correspond to claim patterns and frequencies in the historical claim data, while identifying the one or more emerging trends in claims of the historical claim data may include modeling deviations from the one or more baseline claims (e.g., increases in specific claim types, new claim patterns).

In various embodiments, the modeler 117 may be configured to receive new claim data in real-time from one or more sources. That is, new claim data may be associated with a plurality of customer devices. For example, the new claim data may include real-time sensor data, customer reports, or third-party information (e.g., real-time updates, immediate customer inputs, external databases). That is, the data interface 115 may continuously gather and process incoming data to maintain up-to-date records. Additionally, the new data may be analyzed for emerging patterns or anomalies.

In various implementations, the modeler 117 may be configured to input the new claim data into the trained generative AI or machine learning model to identify at least one of (i) one or more abnormal claims or (ii) an emerging trend in new types of claims or causes of loss. For instance, inputting the new claim data may include preprocessing and normalizing the new claim data (e.g., data cleaning, format standardization, scaling). That is, identifying the one or more abnormal claims may include detecting claims that (i) deviate from at least one of the one or more baseline claims or (ii) correspond to the one or more emerging trends (e.g., suspicious claims, unexpected patterns). Additionally, identifying the emerging trend in new types of claims or causes of loss may include analyzing the frequency, context, and characteristics of the new types of claims or causes of loss (e.g., increasing incidents, geographic patterns, new risk factors).

In some embodiments, the modeler 117 may be configured to generate output data configured to cause the one or more abnormal claims or the emerging trend in the new types of claims or causes of loss to be displayed for user review and analysis to mitigate additional damage to customer tangible property. For example, generating this information may include generating and transmitting a visualization, report, or alert for presentation (e.g., interactive charts, detailed summaries, real-time notifications). That is, the visualized data may help users understand and respond to potential risks. Additionally, mitigating additional damage to customer tangible property may correspond to performing a future action (e.g., preventive measures, policy adjustments, immediate repairs).

In various implementations, the modeler 117 may be configured to determine one or more corrective and/or mitigative actions to reduce, mitigate, and/or prevent the one or more abnormal claims or the emerging trend in the new types of claims or causes of loss. For instance, the one or more corrective and/or mitigative actions may include at least one of (i) issuing warnings to the one or more identified customers, (ii) updating an insurance coverage term, (iii) initiating an inspection, or (iv) deploying a risk mitigation resource (e.g., alerts, policy changes, site visits). That is, these actions may address and manage the identified risks. Additionally, determining the corrective and/or mitigative actions may include analyzing the effectiveness of various measures and implementing the most appropriate ones (e.g., historical data comparisons, effectiveness evaluations).

In some embodiments, the modeler 117 may be configured to identify one or more customers susceptible to the one or more abnormal claims or the emerging trend in the new types of claims or causes of loss. For example, identifying these customers may involve analyzing at least one of (i) customer profiles, (ii) the historical claim data, or (iii) the new claim data (e.g., demographic analysis, claim history review, recent trends). That is, the modeler 117 may identify high-risk customers or properties for targeted intervention.

In some implementations, the modeler 117 may be configured to transmit a message to at least one customer device associated with the one or more identified customers, the message comprising (i) information on the one or more abnormal claims or the emerging trend in the new types of claims or causes of loss and (ii) one or more recommended corrective and/or mitigative actions. For instance, the message may include detailed explanations and visual aids (e.g., charts, graphs, step-by-step guides). That is, the communication may be used to inform and guide the customers on how to address the identified risks. Additionally, the recommended actions may be actionable steps such as installing safety devices, performing regular maintenance, or updating security protocols (e.g., preventive installations, scheduled check-ups, enhanced protections).

### Exemplary Modeling System

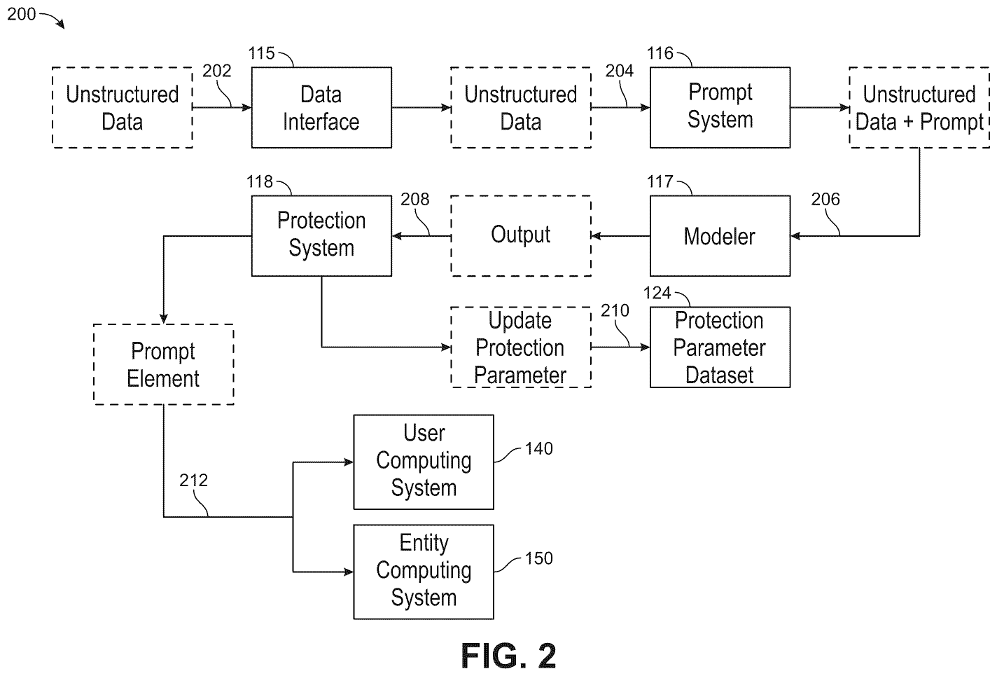

Referring now to FIG. 2, a flow diagram of an exemplary computer-implemented or computer-based process of modeling unstructured data items are shown, according to some embodiments. It should be understood that the solid-lined boxes represent components or systems within the analytics system 100, while the dotted-lined boxes indicate data flow or intermediate data states processed by these components or systems.

At 202, the data interface 115 may receive unstructured data items from various sources (e.g., claim notes, images, videos). For example, unstructured data items may include details associated with a plurality of protection records corresponding to at least one protection product. In some embodiments, the data interface 115 may collect and prepare the unstructured data items for further processing. That is, the data interface 115 may convert the multimedia data into the plurality of data items of at least one protection record (e.g., text conversion, metadata extraction, structured formatting). The data interface 115 may process a variety of data formats and structures.

At 204, once the unstructured data items are received by the data interface 115, it may be forwarded to the prompt system 116. For instance, the unstructured data items may now be in a form suitable for generating prompts (e.g., pre-processed text, annotated images, formatted reports). In various embodiments, the prompt system 116 may analyze this data to extract relevant information and create prompts that may guide the modeler 117. That is, generating the prompt may include extracting one or more associations corresponding to contextual information and attribute information of the plurality of unstructured data items (e.g., keywords, key phrases, data points). The prompt system 116 may generate a prompt for effective modeling and analysis.

At 206, the prompt system 116 may combine the unstructured data items with the generated prompts and send this combined data to the modeler 117. For example, the modeler 117 may model this combined data to generate outputs that provide insights or predictions (e.g., risk assessments, trend analyses, predictive modeling). In various implementations, applying the plurality of unstructured data items and the prompt as the input to the one or more AI models may include transforming the plurality of unstructured data items into a plurality of feature vectors and normalizing the feature vectors to a scale. That is, the combined data may allow the modeler 117 to output accurate and informed predictions (e.g., probability scores, anomaly detection, future trend forecasts). The output from the modeler 117 may be used for further processing by the protection system 118.

At 208, the output generated by the modeler 117 may be sent or otherwise made available to the protection system 118 for analysis and action. For instance, the output may include insights and predictions based upon the unstructured data items and prompts (e.g., updated risk profiles, recommended actions, flagged issues). In certain embodiments, the protection system 118 may use this output to update protection parameters and determine updates regarding claims and policies. That is, the output may include an enhancement to at least one protection parameter of the at least one protection product (e.g., improved deductible parameters, expanded coverage parameters, inclusion of additional product parameters, optimized processing protocols). The protection system 118 may evaluate the outputs to make informed decisions.

At 210, the protection system 118 may update the protection parameters in the protection parameter dataset 124 based upon the output received from the modeler 117. For example, the update may ensure that the protection parameters are current and reflect the latest insights and predictions (e.g., new deductible amounts, revised coverage limits for future insurance product issuance or renewal). In some implementations, the protection parameter dataset 124 may store the updated parameters for future reference and use. That is, maintaining the protection parameters may improve future updates (e.g., future risk assessments, policy updates, regulatory compliance). The updated parameters may be accessed for further analysis and adjustments.

At 212, the prompt element may receive feedback and input from the user computing system 140 and the entity computing system 150. For instance, feedback may be used for refining and improving the prompts and models used by the modeling system 110 (e.g., user comments, error reports, performance metrics). In various implementations, the user computing system 140 and the entity computing system 150 may provide real-time data and feedback to improve the accuracy and responsiveness of modeling system 110. That is, continuous learning and adaptation to new data may be facilitated through this interaction (e.g., automated updates, iterative improvements, real-time adjustments). The prompt element may integrate this feedback into the modeling system 110 to improve overall performance and reliability.

### Exemplary Modeling System & Functionality

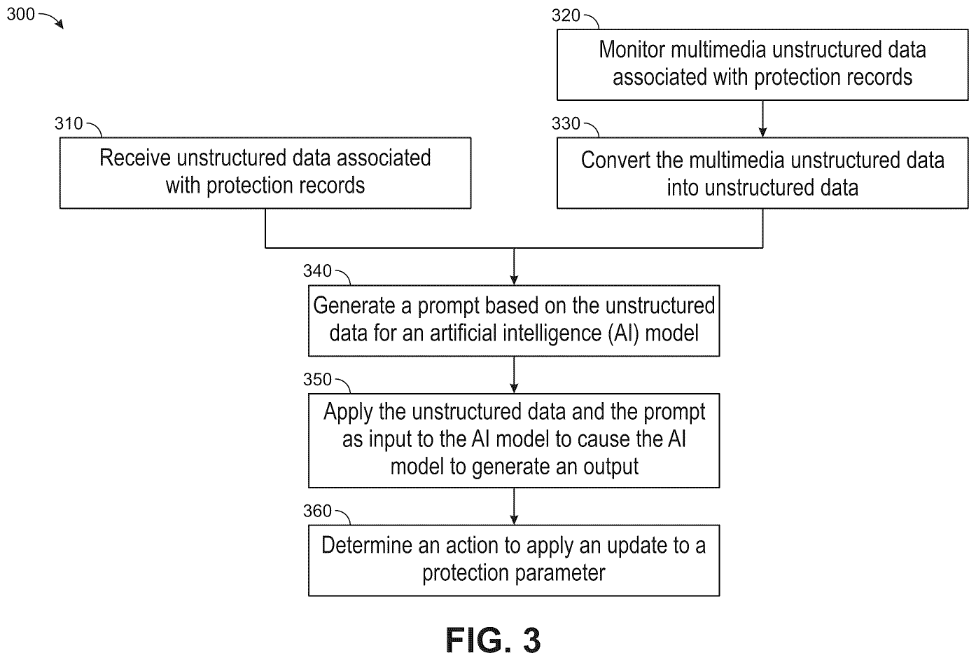

Referring now to FIG. 3, a computer-implemented or computer-based process, shown as process 300, of modeling unstructured data items is shown, according to some embodiments. Computer-implemented process 300 may be implemented by any and/or all the components of the analytics system 100 of FIGS. 1-2 (e.g., the modeling system 110, etc.). It should be appreciated that any and/or all the process 300 may be implemented by other systems, devices, and/or components (e.g., components of the analytics system 100, the modeling system 110, etc.). Further, it should be appreciated that, in various embodiments, process 300 may be implemented using additional, different, and/or fewer operations, actions, and/or functionality.

The computer-implemented method 300 may be implemented via one or more local or remote processors, servers, transceivers, sensors, memory units, mobile devices, wearables, smart watches, smart rings, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another.

Computer-implemented process 300 may include receiving unstructured data items associated with protection records (block 310), according to some embodiments. In certain embodiments, receiving unstructured data items may include the processing circuits collecting data from various sources (e.g., claim notes, customer submissions, internal reports, third-party communications). That is, the processing circuits may aggregate unstructured data items that lacks standardized structure (e.g., non-relational data) for modeling. For example, the unstructured data items may include claim notes, customer communications, and other relevant data.

In various implementations, the processing circuits may receive a plurality of unstructured data items (e.g., text documents, sensor data, social media posts, emails, claim notes) associated with a plurality of protection records. For instance, the plurality of protection records (e.g., service requests, incident reports, maintenance logs, insurance claims) may correspond to at least one protection product (e.g., warranty services, safety monitoring, risk assessments, insurance product). In some implementations, the plurality of unstructured data items corresponds to non-relational data generated by a plurality of sources.

Computer-implemented process 300 may include monitoring multimedia unstructured data items associated with protection records (block 320), according to some embodiments. Monitoring may include the processing circuits continuously or periodically tracking multimedia data such as audio recordings (e.g., call center recordings), video footage (e.g., surveillance videos, customer-provided videos), and images (e.g., photos of damages). For example, the monitoring may be conducted in real-time, near real-time, or on a scheduled basis. In certain embodiments, the processing circuits may use monitoring techniques, such as machine learning algorithms, to detect and flag relevant multimedia data automatically. For instance, the processing circuits may identify and highlight video segments showing damage from an incident or audio clips containing key phrases related to a claim. In another example, image recognition technology may be used to detect photos of damaged property.

In various embodiments, the processing circuits may monitor, using at least one data feed, multimedia unstructured data items associated with at least one protection record. For example, the at least one protection record corresponding to at least one protection product. The data feed may be a real-time data feed, such as a communication session between cellular devices or communication devices.

Computer-implemented process 300 may include converting the multimedia unstructured data items into unstructured data items (block 330), according to some embodiments. That is, the processing circuits may convert the multimedia unstructured data items into a plurality of unstructured data items of the at least one protection record. Converting may include the processing circuits transcribing audio recordings into text, extracting textual information from videos, and digitizing handwritten notes. That is, the processing circuits may transform multimedia data into an unstructured format that may be analyzed with other types of unstructured data items.

For instance, the conversion may include using speech-to-text techniques, optical character recognition (OCR), or other data extraction techniques to standardize the data format. In certain embodiments, the processing circuits may apply natural language processing (NLP) to the converted text to extract unstructured information. For example, OCR may be applied to scanned documents to convert handwritten notes into machine-readable text. The converted data may be integrated with other unstructured data item sources, creating a dataset for analysis.

Computer-implemented process 300 may include generating a prompt based upon the unstructured data items for an artificial intelligence (AI) model (block 340), according to some embodiments. Generating the prompt may include the processing circuits extracting associations and insights from the unstructured data items (e.g., identifying contextual and attribute information). That is, the prompt may be used by the processing circuits as a structured query or command that directs the AI model analysis. For instance, the prompt may be formulated by the processing circuits identifying patterns, correlations, and trends within the unstructured data items to guide the AI model during analysis.

In various implementations, the prompt generation process may be automated using machine learning algorithms. For example, the processing circuits may use clustering techniques to group similar data points and generate prompts based upon these clusters. In another example, the processing circuits may apply association rule mining to identify relationships between different attributes and generate prompts that capture these associations. The generated prompts may be customized to specific analytical actions, such as predicting claim outcomes or identifying fraud patterns.

In some implementations, the processing circuits may generate a prompt based upon the plurality of unstructured data items for one or more artificial intelligence (AI) models. For instance, generating the prompt may include the processing circuits extracting one or more associations (e.g., categories or correlations) corresponding to contextual information and attribute information (e.g., relevant information-contextual being the circumstances, environment, and conditions surrounding the claim, and attribute information being the specific details, characteristics, and properties of the claim itself) of the plurality of unstructured data items.

In some embodiments, the one or more associations extracted from the plurality of unstructured data items may include identifying correlations between the plurality of unstructured data items of the plurality of protection records (e.g., email communications, social media posts, customer service transcripts, claim notes). For example, the contextual information may correspond to circumstantial factors and environmental factors of each of the plurality of protection records (e.g., location descriptions, time-related phrases, environmental conditions mentioned). In another example, the attribute information may correspond to attributes and properties of each of the plurality of protection records (e.g., descriptions of incidents, qualitative assessments of damage, user-reported symptoms).

In various embodiments, the one or more AI models may include a generative AI (GenAI) model. For instance, the GenAI model may include at least one of (i) a supervised learning model trained on labeled protection records of the plurality of protection records or (ii) an unsupervised learning model trained on unlabeled protection records of the plurality of protection records.

In various implementations, the supervised learning model and the unsupervised learning model may include at least one of (i) an association detector to assign the probability metric of the occurrence prediction, or (ii) a pattern tracker to assign the frequency metric of the pattern identification. For example, the association detector and/or pattern tracker may be implemented by the processing circuits using a data structure or code. In certain embodiments, the processing circuits executing the GenAI model may implement reinforcement learning. For instance, the reinforcement learning may include updating the GenAI model based upon receiving feedback on the output and the at least one action from a reward signal generated from performance metrics of the plurality of protection records. That is, the feedback may correspond to at least one user interaction with a user interface.

In some implementations, the GenAI model may be a transformer-based model that may be implemented by tokenizing a large-scale dataset, converting words and subwords into numerical representations (e.g., using algorithms, such as Byte Pair Encoding (BPE) or WordPiece). For instance, the transformer model architecture may include an encoder-decoder structure for sequence-to-sequence tasks or a decoder for language modeling tasks. The architecture may include multi-head self-attention mechanisms and position-wise feed-forward networks. The self-attention mechanisms may weigh the importance of different tokens in a sequence. Positional encodings may be added to token embeddings to retain information about the order of tokens in a sequence. The GAI model may be trained using the tokenized data, performing forward and backward propagation to update model weights using optimization algorithms with a scheduled learning rate, and measuring performance with loss functions such as cross-entropy loss.

In some embodiments, the GenAI model may be an LLM-based model that may be implemented by processing a large-scale dataset to extract patterns and generate predictions. For instance, the LLM model architecture may include layers designed to handle large amounts of data for language modeling tasks. The architecture may use recurrent neural networks (RNNs), long short-term memory (LSTM) networks, or gated recurrent units (GRUs) to manage sequential dependencies. Embeddings may be used to convert words and subwords into numerical representations, retaining information about the semantic relationships between tokens. The GAI model may be trained using this data, performing forward and backward propagation to update model weights using optimization algorithms with a scheduled learning rate, and measuring performance with loss functions such as cross-entropy loss. Techniques like gradient clipping may mitigate exploding gradients, and dropout may prevent overfitting. Post-training, the model may generate text by predicting the next token in a sequence based upon learned patterns, potentially implementing decoding techniques to enhance the relevance of the generated content.

In various embodiments, applying the plurality of unstructured data items and the prompt as the input to the one or more AI models may include the processing circuits transforming the plurality of unstructured data items into a plurality of feature vectors. In various implementations, applying the plurality of unstructured data items and the prompt as the input to the one or more AI models may also include the processing circuits normalizing the plurality of feature vectors to a scale. In some embodiments, applying the plurality of unstructured data items and the prompt as the input to the one or more AI models may also include the processing circuits inputting the normalized plurality of feature vectors into the one or more AI models to perform predictive and pattern recognition to cause the one or more AI models to generate the output.

Computer-implemented process 300 may include applying the unstructured data items and the prompt as input to the AI model to cause the AI model to generate an output (block 350), according to some embodiments. Applying the unstructured data items and prompt may include the processing circuits feeding this combined input into the AI model, which may perform various analytical tasks such as predictive analysis and pattern recognition. That is, the processing circuits, implementing the AI model, may process the input to output actionable insights. For example, the AI model may identify trends, predict future occurrences, or recognize patterns within the unstructured data items based upon the unstructured data items and prompt provided. In some implementations, the AI model may be trained on historical data to improve its accuracy and reliability. For instance, the model may be trained using labeled data to learn patterns associated with specific outcomes. In another example, the model may use unsupervised learning techniques to identify unknown patterns and anomalies in the data.

In certain embodiments, the processing circuits may apply the plurality of unstructured data items and the prompt as input to the one or more AI models (e.g., GenAI model) to cause the one or more AI models to generate an output. The output may be regarding at least one of an occurrence prediction (e.g., forecast of future claim events or trends that may occur) or a pattern identification (e.g., detect recurring claim events or trends, that already occurred) within the plurality of unstructured data items. For instance, the output may include an improvement to at least one protection parameter (e.g., refining underwriting rules, improving policy criteria, optimizing settings, or other parameters of a protection product) of the at least one protection product. That is, the processing circuits may process claim notes, multimedia data, other unstructured data items, and the identified associations (of the prompt) to identify potential future claim events, trends, or patterns.

Computer-implemented process 300 may include determining an action to apply an update to a protection parameter (block 360), according to some embodiments. Determining an action may include the processing circuits analyzing the AI model's output to identify specific updates or changes to protection parameters (e.g., modifications to risk assessments). That is, the insights generated by the AI model may cause the processing circuits to determine actionable updates to protection products.

For instance, the processing circuits may recommend adjustments to protection parameters such as modifying underwriting criteria, updating coverage terms based upon the patterns and predictions identified by the AI model. In various embodiments, the processing circuits may provide automated recommendations and alerts to relevant stakeholders. For example, underwriters may receive notifications about recommended changes to policy terms. In another example, claims adjusters may be alerted to potential fraud cases based upon the model's predictions.

In some embodiments, the processing circuits may determine at least one action to apply the update to the at least one protection parameter of the at least one protection product (e.g., action to change the underwriting rule, policy criteria, settings, etc.). For instance, the at least one action may include a response (e.g., addressing the trends and patterns identified in the multiple protection records) to the plurality of unstructured data items and the prompt. The response may cause a tuning of a probability metric (e.g., reduce losses if/when a future claim occurs) of the occurrence prediction or a tuning of a frequency metric (e.g., remediate recurring claims) of the pattern identification. In various implementations, the enhancement to the at least one protection parameter may be at least one of refining a deductible parameter for at least one future protection product, improving a coverage parameter for the at least one future protection product, enhancing a product inclusion parameter for the at least one future protection product, optimizing a processing protocol parameter for the at least one future protection product, or generating a new query for the at least one future protection product.

In some implementations, the response causing the tuning of the probability metric by the processing circuits may include refining the probability metric to better manage the likelihood (probability) of a future protection record (e.g., future insurance claim). For instance, the response to the identified trend may include performing an action that would reduce a probability of a future claim or reduce losses associated with a future claim. In certain embodiments, the response causing the tuning of the frequency metric of the pattern identification by the processing circuits may include enhancing the frequency metric corresponding with a persistence probability of a subset of the plurality of protection records (e.g., recurring claims, repeated incidents, frequent loss events). For example, the response to the identified trend or pattern may include performing an action that would reduce a probability of a type of claim persisting (e.g., black mold).

In various embodiments, in response to generating the output regarding at least one of the occurrence prediction or the pattern identification within the plurality of protection records, the processing circuits may determine additional data to apply as the input to the one or more AI models (e.g., when additional information may be needed to determine a trend or pattern). In various implementations, the processing circuits may request or access, from at least one data feed, additional data corresponding to the plurality of protection records. For instance, the processing circuits may request detailed incident reports, customer feedback, or supplementary multimedia evidence from various sources to improve the analysis. In some embodiments, the processing circuits may cause a user interface to display the output including a prompt element for receiving user input. For instance, the claim handler or internal user may respond to the GAI output using the prompt element.

In some implementations, the processing circuits may generate, during an active session between a plurality of users, a query according to the at least one action. That is, the active session may include an active connection between a first computing system of a first user and a second computing system of a second user. For instance, the processing circuits may provide claim handlers or other customer communications real-time questions or inquiries to obtain information about the claims from the policy holder. In certain embodiments, the processing circuits may cause the user interface to display the query to at least the first computing system or the second computing system.

### Exemplary Data Flow for Modeling Unstructured Data Items

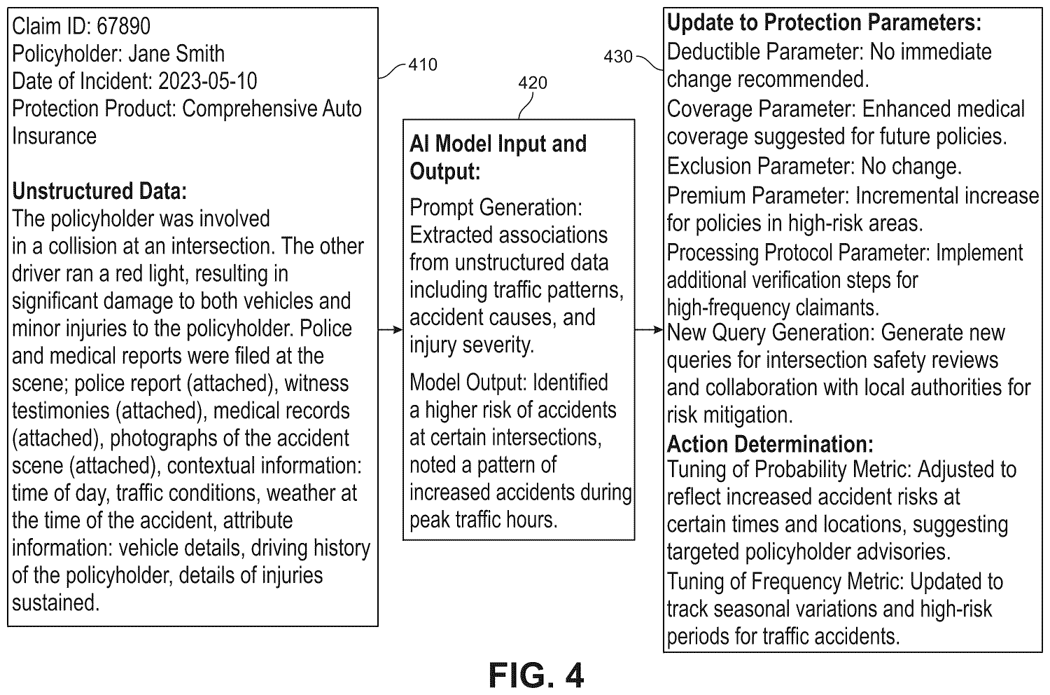

Referring to FIG. 4, an exemplary data flow for modeling unstructured data items is shown, according to some embodiments. As shown, an exemplary embodiment of how the modeling system 110 may model unstructured data items to generate outputs and determine actions to update protection parameters. In block 410, Claim ID: 67890 is shown and may be associated with policyholder Jane Smith, who was involved in a collision at an intersection. The unstructured data items associated with this claim may include police reports, witness testimonies, medical records, photographs of the accident scene, and additional contextual and attribute information. For example, contextual information may include the time of day, traffic conditions, and weather at the time of the accident.

Attribute information may include vehicle details, driving history of the policyholder, and the details of injuries sustained. This data may be a portion of the plurality of protection records that the modeling system 110 may analyze to extract patterns for future predictions. By collecting and/or aggregating this unstructured data items from a plurality of records, the modeling system 110 may better identify the circumstances and characteristics of each claim, improving the accuracy and relevance of its predictions and recommendations. While block 410 illustrates data of one protection record, a plurality of protection records with unstructured data items may be input into the model. In various embodiments, the unstructured data items received by the modeling system 110 may be stored in the protection product dataset 122 of the protection database 120. This dataset may include records of various protection products, historical claims, and associated documentation.

In block 420, the prompt generation process may include extracting associations from the unstructured data items, such as traffic patterns, accident causes, and injury severity. For instance, the prompt system 116 may analyze the unstructured data items from a plurality of protection records to extract relevant information and create prompts to guide the modeler 117. For instance, the modeling system 110 output may identify a higher risk of accidents at certain intersections and determine a pattern of increased accidents during peak traffic hours. That is, the outputs may include predictive models regarding accident risks and trends based upon the analyzed data from the unstructured data items.

In various implementations, the model input and output, implemented by modeling system 110, may provide predictions from unstructured data items. For instance, extracting associations from the unstructured data items may include identifying relevant traffic patterns and accident causes from various protection records. The prompt system 116 uses this information to generate specific prompts for the AI models to analyze. The resulting model output may indicate higher accident risks at particular intersections and increased accident rates during peak hours. This analysis facilitates the identification of areas and times where accidents are more likely to occur, providing the modeling system 110 insight for potential parameter updates, e.g., policy adjustments, advertisement adjustments, policy language adjustments, etc.

In block 430, the modeling system 110 may recommend an action to update a coverage parameter to include enhanced medical coverage for future policies, focusing on providing additional benefits to policyholders. Additionally, based upon the unstructured data items, the modeling system 110 may determine an action to mitigate risk for policy holders in high-risk areas, such as replace home or vehicle parts, systems, or software.

In various implementations, action determinations by the modeling system 110 may include optimizing the probability metric to reflect identified accident risks at certain times and locations and suggesting targeted policyholder advisories for improved safety. For example, based upon the AI model output, the modeling system 110 may recommend enhanced medical coverage for future policies in areas with higher accident risks. The refinement of the frequency metric may be updated to track seasonal variations and high-risk periods for traffic accidents to ensure timely and effective responses. The tuning (or refinement) of probability and frequency metrics may enhance the responsiveness of the modelling system 110 to emerging trends and seasonal variations, improving its predictive accuracy and effectiveness in protection management.

### Additional Exemplary Data Flow for Modeling Unstructured Data Items

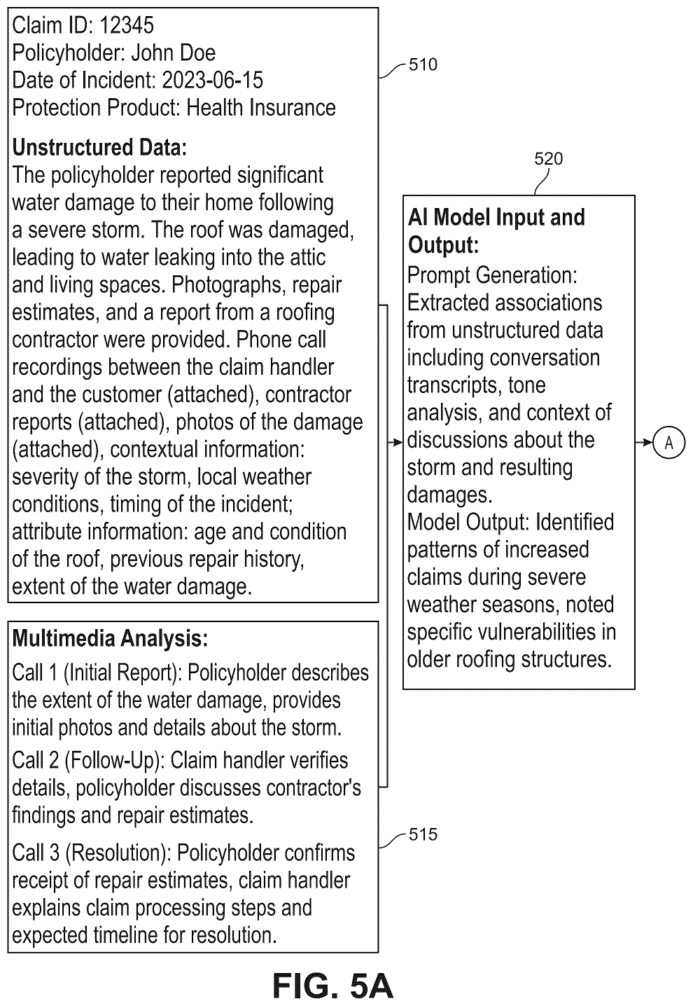

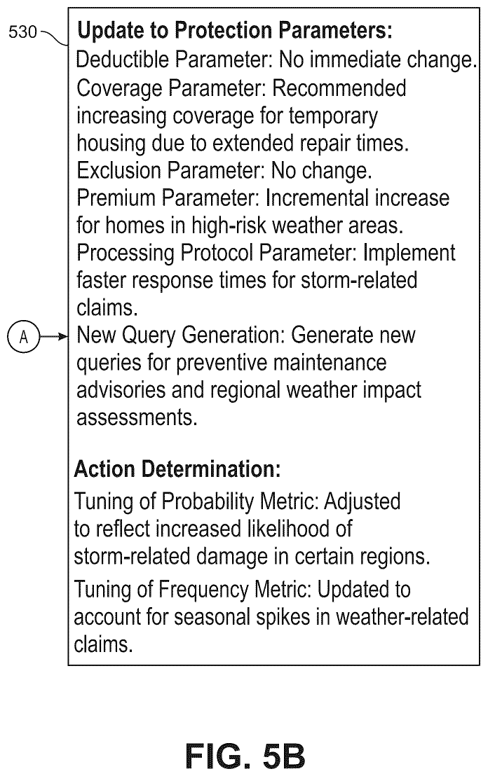

Referring to FIGS. 5A-5B, is another exemplary data flow for modeling unstructured data items is shown, according to some embodiments. The analytics system 200 may include various components for processing unstructured data items and generating model outputs and protection parameter updates. As depicted in block 510, unstructured data items may include various types of information provided by the policyholder and other sources. This data may include water damage reports, witness testimonies, insurance claims, photographs of the water damage, and contextual information such as time of day, weather conditions, and previous incidents of water damage in the area.

The unstructured data items may also include attribute information including property details, history of water damage claims by the policyholder, and details of the damage sustained (e.g., in an unstructured format). While block 510 illustrates data of one protection record, a plurality of protection records with unstructured data items may be input into the model. In some implementations, the unstructured data items received by the modeling system 110 may be stored in the protection product dataset 122 of the protection database 120. This dataset may include records of various protection products, historical claims, and associated documentation.

In block 515, the modeling system 110 may process various multimedia data associated with the protection records. For instance, multimedia data may include phone recordings, follow-up communications, and resolution steps captured in different formats such as audio recordings, videos, and images. In various implementations, multimedia analysis may include transcribing audio recordings from phone calls between the policyholder and the claim handler, extracting information from photographs of the damage, and extracting data items from video footage. The multimedia data may be integrated and/or aggregated into the other unstructured data items.

In block 520, the modeling system 110 may process the unstructured data items to identify patterns and trends that inform updates to protection parameters. For instance, multiple records of water damage claims during severe weather may be analyzed to determine common factors and inform future coverage adjustments. By aggregating and analyzing unstructured data items from a plurality of protection records, the modeling system 110 may generate outputs that improve prediction accuracy and decision-making processes. As shown, block 520 depicts the AI model input and output process, where the modeling system 110 generates prompts based upon the unstructured data items. These prompts may be used to extract associations from the data, including contextual and attribute information, which are then input into the AI models.

The modeling system 110, using one or more AI models, may process the data to identify correlations and trends that may not be immediately apparent. For instance, the model output may reveal a pattern of increased accidents in specific weather conditions or times of day. These insights may be used to enhance protection parameters (e.g., expanding coverage options, offering premium discounts), such as adjusting coverage options for high-risk areas or implementing new safety measures. By continuously analyzing and modeling unstructured data items from a plurality of protection records, the modeling system 110 may improve its predictive capabilities and provide more accurate recommendations.

At block 530, the modeling system 110 may use the outputs generated by the AI models to determine updates to various protection parameters. For example, by rewarding lower-risk individuals with a reduced deductible, the deductible parameter may be optimized (or adjusted) based on the likelihood of fewer future claims, and coverage parameters may be enhanced to address specific risks identified by the model. The modeling system 110 may also generate new queries for further analysis and collaboration with external entities, such as local authorities, to remediate identified trends. In various embodiments, the modeling system 110 may implement changes to protection parameters based upon the model output. For instance, if the modeling system 110 identifies a high risk of water damage in certain areas, the modeling system 110 may enhance coverage options for those areas and implement optimized processing protocols to expedite claims. Additionally, the modeling system 110 may generate new queries to refine the models and gather additional data for future analysis.

### Exemplary Computing System

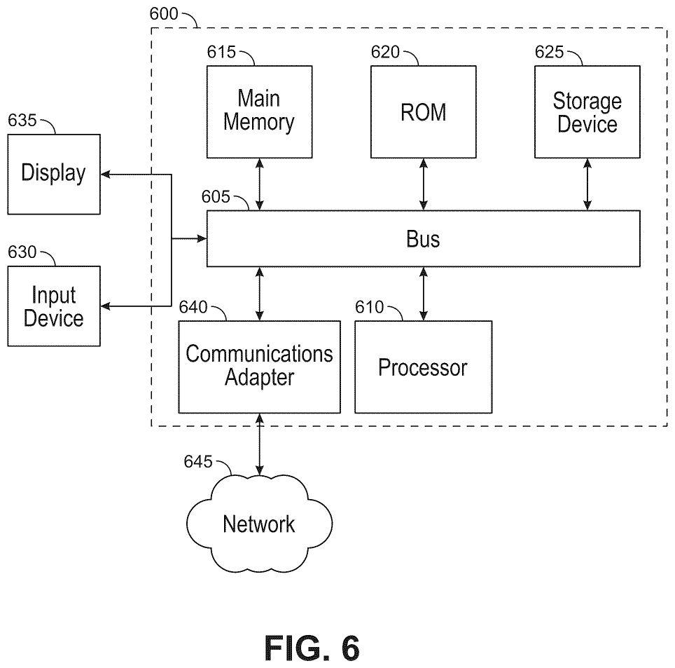

Referring now to FIG. 6, a depiction of a computer system 600 is shown. The computer system 600 that may be used, for instance, to implement a computing environment (e.g., analytics system 100), the modeling system 110, the user computing systems 140, the entity computing systems 150, and/or various other example systems described in the present disclosure. The computing system 600 includes a bus 605 or other communication component for communicating information and a processor 610 coupled to the bus 605 for processing information. The computing system 600 also includes main memory 615, such as a random-access memory (RAM) or other dynamic storage device, coupled to the bus 605 for storing information, and instructions to be executed by the processor 610.

Main memory 615 may also be used for storing position information, temporary variables, or other intermediate information during execution of instructions by the processor 610. The computing system 600 may further include a read-only memory (ROM) 620 or other static storage device coupled to the bus 605 for storing static information and instructions for the processor 610. A storage device 625, such as a solid-state device, magnetic disk or optical disk, is coupled to the bus 605 for persistently storing information and instructions.

The computing system 600 may be coupled via the bus 605 to a display 635, such as a liquid crystal display, or active-matrix display, for displaying information to a user. An input device 630, such as a keyboard including alphanumeric and other keys, may be coupled to the bus 605 for communicating information, and command selections to the processor 610. In another implementation, the input device 630 has a touch screen display 635. The input device 630 may include any type of biometric sensor, a cursor control, such as a mouse, a trackball, or cursor direction keys, for communicating direction information and command selections to the processor 610 and for controlling cursor movement on the display 635.

In some implementation, the computing system 600 may include a communications adapter 640, such as a networking adapter. Communications adapter 640 may be coupled to bus 605 and may be configured to facilitate communications with a computing or communications network 645 (similar features and functionality as network 130 of FIG. 1) and/or other computing systems. In various illustrative implementations, any type of networking configuration may be achieved using communications adapter 640, such as wired (e.g., via Ethernet), wireless (e.g., via Wi-Fi, Bluetooth), satellite (e.g., via GPS) pre-configured, ad-hoc, LAN, WAN.

According to various implementations, the processes that effectuate illustrative implementations that are described herein may be achieved by the computing system 600 in response to the processor 610 executing an implementation of instructions contained in main memory 615. Such instructions may be read into main memory 615 from another computer-readable medium, such as the storage device 625. Execution of the implementation of instructions contained in main memory 615 causes the computing system 600 to perform the illustrative processes described herein.

One or more processors in a multi-processing implementation may also be employed to execute the instructions contained in main memory 615. In alternative implementations, hard-wired circuitry may be used in place of or in combination with software instructions to implement illustrative implementations. Thus, implementations are not limited to any specific combination of hardware circuitry and software.

That is, although an example processing system has been described in FIG. 6, implementations of the subject matter and the functional operations described in this specification may be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Implementations of the subject matter described in this specification may be implemented as one or more computer programs, e.g., one or more subsystems of computer program instructions, encoded on one or more computer storage medium for execution by, or to control the operation of, data processing apparatus.

Alternatively, or in addition, the program instructions may be encoded on an artificially generated propagated signal, e.g., a machine generated electrical, optical, or electromagnetic signal, that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate components or media (e.g., multiple CDs, disks, or other storage devices). Accordingly, the computer storage medium is both tangible and non-transitory.

Although shown in the implementations of FIG. 6 as singular, stand-alone devices, one of ordinary skill in the art will appreciate that, in some implementations, the computing system 600 may include virtualized systems and/or system resources. For instance, in some implementations, the computing system 600 may be a virtual switch, virtual router, virtual host, virtual server. In various implementations, computing system 600 may share physical storage, hardware, and other resources with other virtual machines. In some implementations, virtual resources of the network may include cloud computing resources such that a virtual resource may rely on distributed processing across more than one physical processor, distributed memory, etc.

### Exemplary Model Training & Functionality

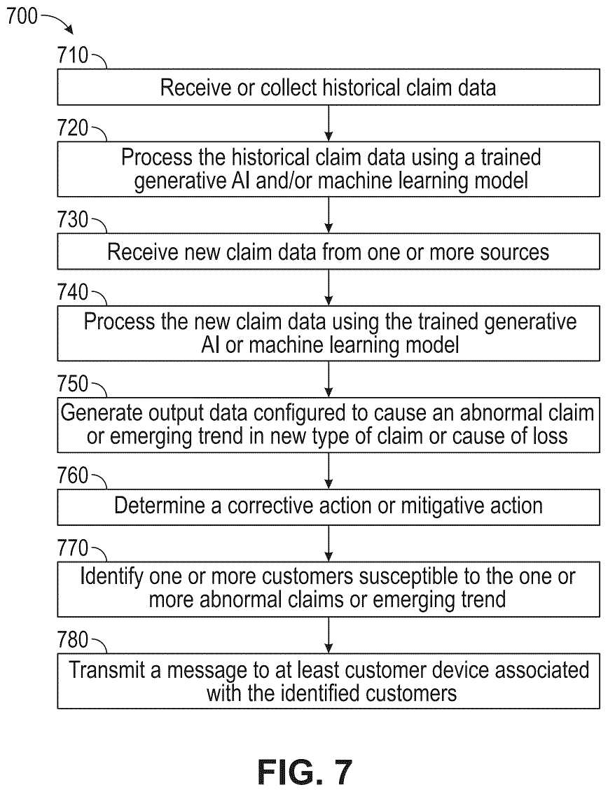

Referring now to FIG. 7, a computer-implemented or computer-based process, shown as process 700, of model training is shown, according to some embodiments. Generally, process 700 relates to identifying emerging trends in insurance claims and mitigating damage via one or more processors, transceivers, sensors, servers, memory units. Computer-implemented process 700 may be implemented by any and/or all the components of the analytics system 100 of FIGS. 1-2 (e.g., the modeling system 110, etc.). It should be appreciated that any and/or all the process 700 may be implemented by other systems, devices, and/or components (e.g., components of the analytics system 100, the modeling system 110, etc.). Further, it should be appreciated that, in various embodiments, process 700 may be implemented using additional, different, and/or fewer operations, actions, and/or functionality.

The computer-implemented method 700 may be implemented via one or more local or remote processors, servers, transceivers, sensors, memory units, mobile devices, wearables, smart watches, smart rings, smart contact lenses, smart glasses, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another.

Computer-implemented process 700 may include receiving historical claim data from at least one of one or more sensors or one or more databases (block 710), according to some embodiments. In certain embodiments, receiving historical claim data may include the processing circuits aggregating data from multiple sources, transforming the data into a usable format, and storing it for further analysis. That is, the processing circuits may process and standardize the data for consistency. For example, the historical claim data may include homeowners claim data, auto claim data, medical claim data, commercial property claim data, and other types of insurance claims. In some embodiments, the historical claim data may correspond to insurance claims data (e.g., policyholder reports, adjuster notes, repair estimates, medical records). For example, the data may be used to identify common factors in past claims. Additionally, the at least one of one or more sensors or one or more databases may include home-mounted sensors, smart vehicle sensors, smart infrastructure, customer mobile devices, cloud storage systems, local databases, networked servers, or any similar data source.

Computer-implemented process 700 may include processing the historical claim data using a trained generative AI and/or machine learning model to identify at least one of (i) one or more baseline claims or (ii) one or more emerging trends in claims of the historical claim data (block 720), according to some embodiments. Processing may include the processing circuits preprocessing the data to remove noise and anomalies. That is, the processing circuits may clean and normalize the data for accurate analysis. For example, preprocessing might include the processing circuits removing duplicate entries or correcting data inconsistencies.

Additionally, the one or more baseline claims (or normal) may be typical auto accidents, common weather-related damages, frequent minor injuries, routine medical claims, or any regular claim pattern. That is, the baseline claims may be identified by the processing circuits based on historical data patterns. Specifically, the one or more baseline claims may correspond to claim patterns and frequencies in the historical claim data. In some embodiments, the one or more emerging trends in claims of the historical claim data may be new types of fraud, unusual patterns of claims, spikes in certain claim categories, increased claims in specific regions, or any similar anomaly. For instance, an emerging trend may be identified by a sudden increase in claims related to a specific event. In another instance, an emerging trend may be identified by changes in the nature of claims over time.

Referring to processing (or inputting) and training generally, the model may be updated continuously with new data. In various embodiments, training may include supervised learning using labeled data or unsupervised learning to discover patterns. That is, the trained generative AI or machine learning model may be trained using a dataset including labeled historical insurance claims from a plurality of data sources (e.g., customer reports, sensor data, third-party reports, adjuster notes). For example, labeled historical insurance claims may be categorized by type and severity. In another example, labeled historical insurance claims may be annotated with the outcomes. In some embodiments, the generative AI model may be trained by using the dataset and reinforcement learning techniques.

In some implementations, the machine learning model may be trained by using the dataset and cross-validation methods. Additionally, the labeled historical insurance claims may include at least one of customer reports, sensor data, or third-party information. For instance, a customer report may provide detailed descriptions of incidents. In another instance, the sensor data may provide real-time evidence of the events. In yet another instance, the third-party information may validate the claims through independent sources.

In some embodiments, identifying, by the trained generative AI or machine learning model, the one or more baseline claims may include the processing circuits modeling historical claim patterns, frequencies, and characteristics to generate a reference model. That is, the reference model may provide a benchmark for detecting anomalies. For instance, historical claim patterns may be modeled by the processing circuits by analyzing the distribution and frequency of claim types over time. In another instance, frequencies may be modeled by the processing circuits by tracking the occurrence rate of specific claims. In yet another instance, characteristics may be modeled by the processing circuits by analyzing the attributes of each claim. That is, the reference model (e.g., trained generative AI or machine learning model) may be trained to differentiate between normal and abnormal claims.

In some embodiments, identifying, by the trained generative AI or machine learning model, the one or more emerging trends in claims of the historical claim data may include the processing circuits modeling deviations from the one or more baseline claims. That is, modeling deviations may include the processing circuits identifying increases in specific claim types (e.g., weather-related claims, fraud-related claims, injury-related claims, mechanical failure claims) or new claim patterns (e.g., sudden spikes in a particular claim category, unusual claim amounts, novel types of damage). In some embodiments, the one or more emerging trends in claims of the historical claim data may correspond to the new claim patterns or increased frequencies of the specific claim types indicating the one or more emerging trends. For example, the processing circuits may model the deviations to output an emerging trend based on the new claim patterns by using clustering algorithms. In another example, the processing circuits may model the deviations to output an emerging trend based on the increased frequencies of the specific claim types by applying time-series analysis.

Computer-implemented process 700 may include receiving new claim data in real-time (or near real-time) from one or more sources, the new claim data associated with a plurality of customer devices (block 730), according to some embodiments. That is, the processing circuits may set up continuous data feeds from sensors and user submissions. The new claims data may include real-time sensor data, customer reports, third-party information, or any relevant data source. For instance, new claims data received by the processing circuits associated with real-time sensor data may be automatically uploaded and analyzed. In another instance, new claims data received by the processing circuits associated with customer reports may be manually submitted and verified. In yet another instance, new claims data received by the processing circuits associated with third-party information may be cross-referenced for accuracy.

In some embodiments, the one or more sources may be home sensors, vehicle sensors, mobile devices, claim notes, surveillance cameras, weather stations, or any similar data source. For instance, a source may be a networked home security system. In some embodiments, the plurality of customer devices may be smartphones, tablets, laptops, or smart home devices. For instance, a customer device may be a smartphone with an insurance app installed.

Computer-implemented process 700 may include processing the new claim data using the trained generative AI and/or machine learning model to identify at least one of (i) one or more abnormal claims or (ii) an emerging trend in new types of claims or causes of loss (block 740), according to some embodiments. That is, the processing circuits may analyze the new data in the context of the reference model (e.g., trained model). For example, the one or more abnormal claims or emerging trends may be from faulty home construction material, faulty vehicle parts or systems, or sub-par cyber security software.

In some implementations, processing (or inputting or feeding) the new claim data into the trained generative AI or machine learning model may include preprocessing and normalizing the new claim data. In some embodiments, preprocessing the new claim data may include filtering out irrelevant or redundant information. For instance, the processing circuits may remove non-claim related entries. In various implementations, normalizing the new claim data may include scaling the data to fit within the expected range of values. For instance, the processing circuits may adjust the data to account for seasonal variations.

In some embodiments, one or more abnormal claims may include claims with unusually high payouts, claims with atypical damage descriptions, claims filed under suspicious circumstances, claims with rapid follow-up incidents, or any unexpected claim pattern. For instance, an abnormal claim may be a series of claims filed shortly after a policy is issued. In some implementations, identifying, by the trained generative AI or machine learning model, the one or more abnormal claims may include the processing circuits detecting claims that (i) deviate from at least one of the one or more baseline claims or (ii) correspond to the one or more emerging trends. That is, the processing circuits may detect claims by comparing new data against the established reference model. For example, the processing circuits may detect claims that deviate from at least one of the one or more baseline claims by flagging outliers. In another example, the processing circuits may detect claims that correspond to the one or more emerging trends by recognizing new patterns.

In some embodiments, identifying, by the trained generative AI or machine learning model, the emerging trend in the new types of claims or causes of loss may include the processing circuits analyzing a frequency, context, and characteristics of the new types of claims or causes of loss. That is, the processing circuits may analyze new types of claims or causes of loss by sorting the data into its parts. For example, the processing circuits may analyze a frequency (e.g., weekly occurrences, monthly spikes, seasonal variations) by plotting the data over time. In another example, the processing circuits may analyze a context (e.g., geographic location, economic conditions, weather events) by correlating claims with external factors. In yet another example, the processing circuits may analyze characteristics (e.g., claim amounts, types of damage, claimant demographics) by categorizing the data.

Computer-implemented process 700 may include generating output data configured to cause the one or more abnormal claims or the emerging trend in the new types of claims or causes of loss to be displayed for user review and analysis to mitigate additional damage to customer tangible property (block 750), according to some embodiments. That is, the processing circuits may generate visual reports or other graphic user interface elements for interaction by the customer. In some embodiments, generating the output data configured to cause the one or more abnormal claims or the emerging trend in the new types of claims or causes of loss may include generating and transmitting a visualization, report, or alert for presentation. For instance, an interactive dashboard may depict real-time data. The customer tangible property may be customer belongings, homes, vehicles, business properties, electronic devices, or any physical asset. In some implementations, mitigating additional damage to customer tangible property may correspond to performing a future action (e.g., issuing warnings, updating policies, initiating inspections). For example, the processing circuits may send alerts to customers in high-risk areas.

Computer-implemented process 700 may include determining one or more corrective and/or mitigative actions to reduce, mitigate, and/or prevent the one or more abnormal claims or the emerging trend in the new types of claims or causes of loss (block 760), according to some embodiments. That is, the processing circuits may recommend actionable steps. In some embodiments, the corrective action may be updating software to prevent security breaches or upgrading a building material in a house to reduce a potential hazard. For example, the processing circuits may suggest patches or upgrades or material to use. In various embodiments, the mitigative action may be enhancing physical security measures. For instance, the processing circuits may recommend installing new locks or cameras.

In some embodiments, the one or more corrective and/or mitigative actions may include at least one of (i) issuing warnings to the one or more identified customers, (ii) updating an insurance coverage term, (iii) initiating an inspection, or (iv) deploying a risk mitigation resource.

For instance, issuing warnings to the one or more identified customers by the processing circuits may include sending automated alerts via email or SMS. In another instance, enhancing an insurance coverage term by the processing circuits may include reducing deductibles or improving coverage limits. In yet another instance, initiating an inspection by the processing circuits may include scheduling on-site visits by professionals. In yet another instance, deploying a risk mitigation resource by the processing circuits may include dispatching emergency response teams or providing temporary protective measures.

In some implementations, determining one or more corrective and/or mitigative actions to reduce the one or more abnormal claims or the emerging trend in the new types of claims or causes of loss may include the processing circuits analyzing an effectiveness of a plurality of measures and implementing at least one of the plurality of measures. For instance, the effectiveness of the plurality of measures may be evaluated through simulation models or historical data analysis. In this instance, implementing the at least one of the plurality of measures may include selecting the most cost-effective or efficient option.

In some implementations, determining one or more corrective and/or mitigative actions to mitigate the one or more abnormal claims or the emerging trend in the new types of claims or causes of loss may include implementing one or more mitigative measures. For example, implementing one or more mitigative measures may include the processing circuits deploying automated monitoring systems. In another example, implementing one or more mitigative measures may include the processing circuits enhancing policyholder education on risk prevention.

Further mitigative measures may include, via one or more processors, servers, transceivers, sensors, or other electronic components or devices, (i) identifying faulty parts, components, systems, or materials; (ii) ordering replacement parts, components, systems, or materials; (iii) repairing faulty parts, components, systems, or materials; and/or (iv) scheduling a time for repair or replacement of faulty parts, components, systems, or materials (such as scheduling a time to take a vehicle with a faulty part or system to repair shop or dealership for repair; scheduling a time with a service provider to repair faulty appliances within the home or replace sub-par construction materials within or on the home; scheduling a time for a service provider to update computer software on vehicles or smart home equipment to improve cybersecurity; etc.) These mitigative measures may be fully or partially automated and carried out by processors, and/or pre-approved or approved by the customer, such as via communication and/or customer interaction with their mobile device.

Further mitigative measures may include, via one or more processors, servers, transceivers, sensors, or other electronic components or devices, (i) identifying faulty parts, components, systems, or materials; (ii) ordering replacement parts, components, systems, or materials; (iii) repairing faulty parts, components, systems, or materials; and/or (iv) scheduling a time for repair or replacement of faulty parts, components, systems, or materials (such as scheduling a time to take a vehicle with a faulty part or system to the repair shop or dealership for repair; scheduling a time with a service provider to repair faulty appliances within the home or replace sub-par construction materials within or on the home; scheduling a time for a service provider to update computer software on vehicles or smart home equipment to improve cybersecurity; etc.). These mitigative measures may be fully or partially automated and carried out by processors, and/or pre-approved or approved by the customer, such as via communication and/or customer interaction with their mobile device.

In some implementations, determining one or more corrective and/or mitigative actions to prevent the one or more abnormal claims or the emerging trend in the new types of claims or causes of loss may include a preemptive measure. For example, determining the preemptive measures may include the processing circuits deploying early warning systems. In another example, determining the preemptive measures may include the processing circuits creating predictive maintenance schedules.

Computer-implemented process 700 may include identifying one or more customers susceptible to the one or more abnormal claims or the emerging trend in the new types of claims or causes of loss (block 770), according to some embodiments. That is, the processing circuits may analyze customer data to pinpoint high-risk individuals. For instance, one or more susceptible customers may be those with high claim frequencies, located in high-risk areas, having older properties, or any similar risk factor. Additionally, susceptibility may be determined by historical data patterns. That is, a susceptibility of customers may be quantified by calculating risk scores based on historical and current data.

In some embodiments, identifying one or more customers susceptible to the one or more abnormal claims or the emerging trend in the new types of claims or causes of loss may include the processing circuits analyzing at least one of (i) customer profiles, (ii) the historical claim data, and (iii) the new claim data to identify the one or more customers or the customer tangible property at increased risk of the one or more abnormal claims or the emerging trend in the new types of claims or causes of loss. That is, the increased risk may correspond to high frequency of past claims, location-specific risks, seasonal patterns, lifestyle factors, or any similar indicator. For example, the processing circuits may analyze customer profiles (e.g., demographics, claim history) to identify patterns. In another example, the processing circuits may analyze historical claim data (e.g., types of past claims, times of occurrence) to predict future risks. In yet another example, the processing circuits may analyze new claim data (e.g., recent incidents, emerging issues) to detect trends.

Computer-implemented process 700 may include transmitting a message to the at least one customer device associated with the one or more identified customers, the message including (i) information on the one or more abnormal claims or the emerging trend in the new types of claims or causes of loss and (ii) one or more recommended corrective and/or mitigative actions (block 780), according to some embodiments. That is, the processing circuits may generate and send notifications. For instance, the processing circuits may generate the message to include detailed explanations of the identified risks and personalized recommendations. In another instance, the processing circuits may generate the message to include visual aids like charts or graphs for better understanding.

In some embodiments, the message transmitted by the processing circuits may be via email, SMS, app notifications, or any secure communication channel. Additionally, information on the one or more abnormal claims or the emerging trend in the new types of claims or causes of loss may include statistical data, analysis results, or trend summaries. For instance, the message might detail recent spikes in specific claim types. Furthermore, the one or more recommended corrective and/or mitigative actions may include actionable steps such as installing safety devices, performing regular maintenance, or updating security protocols. For example, advising customers to install water leak detectors if a trend in water damage claims is detected.

### Exemplary Machine Learning and Generative AI

As discussed elsewhere, some embodiments may utilize machine learning, generative artificial intelligence, or other advanced computing techniques. As such, in various implementations, generative artificial intelligence (AI) models (also referred to as generative machine learning (ML) models) and/or other AI/ML models discussed herein may be implemented via and/or coupled to one or more voice bots and/or chatbots that may be configured to utilize artificial intelligence and/or machine learning techniques. For instance, the voice and/or chatbot may be a ChatGPT chatbot and/or a ChatGPT-based bot. The voice and/or chatbot may employ supervised, unsupervised, and/or semi-supervised machine learning techniques, which may be followed by, and/or used in conjunction with, reinforced and/or reinforcement learning techniques. The voice bot, chatbot, ChatGPT bot, ChatGPT-based bot, and/or other such generative model may generate audible or verbal output, text or textual output, visual or graphical output, output for use with speakers and/or display screens of a mobile computing device, and/or other types of output for user and/or other computer or bot consumption.

Noted above, in some implementations, a chatbot or other computing device may be configured to implement machine learning, such that the computing device “learns” to analyze, organize, and/or process data without being explicitly programmed. Machine learning and/or artificial intelligence may be implemented through machine learning methods and algorithms. In one exemplary embodiment, a machine learning module may be configured to implement the ML methods and algorithms.

As used herein, a voice bot, chatbot, ChatGPT bot, ChatGPT-based bot, and/or other such generative model (referred to broadly as “chatbot” herein) may refer to a specialized system for implementing, training, utilizing, and/or otherwise providing an AI or ML model to a user for dialogue interaction (e.g., “chatting”). Depending on the embodiment, the chatbot may utilize and/or be trained according to language models, such as natural language processing (NLP) models and/or large language models (LLMs). Similarly, the chatbot may utilize and/or be trained according to generative adversarial network (GAN) techniques, such as the machine learning techniques, algorithms, and systems described in more detail below.

The chatbot may receive inputs from a user via text input, spoken input, gesture input, etc. The chatbot may then use AI and/or ML techniques as described herein to process and analyze the input before determining an output and displaying the output to the user. Depending on the embodiment, the output may be in a same or different form than the input (e.g., spoken, text, gestures, etc.), may include images, and/or may otherwise communicate the output to the user in an overarching dialogue format.

In various embodiments, at least one of a plurality of ML methods and algorithms may be applied to implement and/or train the chatbot, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, a chatbot ML module employs supervised learning, which involves identifying patterns in existing data to make predictions about subsequently received data. Specifically, the chatbot ML module may be “trained” using training data, which includes example inputs and associated example outputs. Based upon the training data, the chatbot ML module may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiment, a processing element may be trained by providing it with a large sample of data with known characteristics or features.

In another embodiment, the chatbot ML module may employ unsupervised learning, which involves finding meaningful relationships in unorganized data. Unlike supervised learning, unsupervised learning does not involve user-initiated training based upon example inputs with associated outputs. Rather, in unsupervised learning, the chatbot ML module may organize unlabeled data according to a relationship determined by at least one ML method/algorithm employed by the chatbot ML module. Unorganized data may include any combination of data inputs and/or ML outputs as described above.

In yet another embodiment, the chatbot ML module may employ semi-supervised learning, which involves using thousands of individual supervised machine learning iterations to generate a structure across the multiple inputs and outputs. In this way, the chatbot ML module may be able to find meaningful relationships in the data, similar to unsupervised learning, while leveraging known characteristics or features in the data to make predictions via a ML output.

In yet another embodiment, the chatbot ML module may employ reinforcement learning, which involves optimizing outputs based upon feedback from a reward signal. Specifically, the chatbot ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In certain embodiments, the chatbot ML module may be used in conjunction with the machine vision, image recognition, object identification, AR glasses, VR headsets, other input/output devices, and/or other image processing techniques discussed below. Additionally or alternatively, In certain embodiments, the chatbot ML module may be configured and/or trained to implement one or more aspects of the machine vision, image recognition, objection identification, and/or other image processing techniques discussed below.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory.

The above memory types are example only and are thus not limiting as to the types of memory usable for storage of a computer program.

In various implementations, a computer program is provided, and the program is embodied on a computer readable medium. In various embodiments, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In various implementations, the system includes multiple components distributed among a plurality of computing devices. One or more components may be in the form of computer-executable instructions embodied in a computer-readable medium. The systems and processes are not limited to the specific embodiments described herein. In addition, components of each system and each process may be practiced independent and separate from other components and processes described herein. Each component and process may also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For instance, the position of elements may be reversed or otherwise varied, and the nature or number of discrete elements or positions may be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions may be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112 (f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations may be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations may be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A modeling system for modeling unstructured data items using artificial intelligence (AI) models, comprising:
one or more memory devices having instructions stored thereon that, when executed by one or more processors, cause the one or more processors to perform operations comprising:
receiving a plurality of unstructured data items associated with a plurality of protection records, the plurality of protection records corresponding to at least one protection product;
generating a prompt based upon the plurality of unstructured data items for one or more AI models, wherein generating the prompt comprises extracting one or more associations corresponding to contextual information and attribute information of the plurality of unstructured data items;
applying the plurality of unstructured data items and the prompt as input to the one or more AI models to cause the one or more AI models to generate an output regarding at least one of an occurrence prediction or a pattern identification within the plurality of unstructured data items, wherein the output comprises an update to at least one protection parameter of the at least one protection product; and
determining at least one action to apply the update to the at least one protection parameter of the at least one protection product, wherein the at least one action comprises a response to the plurality of unstructured data items and the prompt, the response causing a tuning of a probability metric of the occurrence prediction or a tuning of a frequency metric of the pattern identification.

2. The modeling system of claim 1, wherein the operations further comprising:
monitoring, using at least one data feed, multimedia data of at least one protection record of the plurality of protection records, the at least one protection record corresponding to the at least one protection product; and
converting the multimedia data into the plurality of unstructured data items of the at least one protection record.

3. The modeling system of claim 1, wherein the plurality of unstructured data items corresponds to non-relational data generated by a plurality of sources, and wherein applying the plurality of unstructured data items and the prompt as the input to the one or more AI models comprises:
transforming the plurality of unstructured data items into a plurality of feature vectors;
normalizing the plurality of feature vectors to a scale; and
inputting the normalized plurality of feature vectors into the one or more AI models to perform predictive and pattern recognition to cause the one or more AI models to generate the output.

4. The modeling system of claim 1, wherein the one or more AI models comprise a generative AI model, and wherein the generative AI model comprise at least one of (i) a supervised learning model trained on labeled protection records of the plurality of protection records or (ii) an unsupervised learning model trained on unlabeled protection records of the plurality of protection records.

5. The modeling system of claim 4, wherein the supervised learning model and the unsupervised learning model comprise at least one of (i) an association detector to assign the probability metric of the occurrence prediction, or (ii) a pattern tracker to assign the frequency metric of the pattern identification.

6. The modeling system of claim 5, wherein the generative AI model implements reinforcement learning, wherein the reinforcement learning comprises updating the generative AI model based upon receiving feedback on the output and the at least one action from a reward signal generated from performance metrics of the plurality of protection records, the feedback corresponding to at least one user interaction with a user interface.

7. The modeling system of claim 1, wherein the update to the at least one protection parameter is at least one of updating a deductible parameter for at least one future protection product, updating a coverage parameter for the at least one future protection product, updating a processing protocol parameter for the at least one future protection product, or generating a new query for the at least one future protection product.

8. The modeling system of claim 1, wherein the response causing the tuning of the probability metric comprises reducing the probability metric corresponding with reducing a probability of a future protection record, and wherein the response causing the tuning of the frequency metric of the pattern identification comprises updating the frequency metric corresponding with a persistence probability of a subset of the plurality of protection records.

9. The modeling system of claim 1, wherein the one or more associations extracted from the plurality of unstructured data items comprises identifying correlations between the plurality of unstructured data items of the plurality of protection records, and wherein the contextual information corresponds to circumstantial factors and environmental factors of each of the plurality of protection records, and the attribute information corresponds to attributes and properties of each of the plurality of protection records.

10. The modeling system of claim 1, wherein the operations further comprising:
in response to generating the output regarding at least one of the occurrence prediction or the pattern identification within the plurality of protection records, determining additional data to apply as the input to the one or more AI models; and
requesting or accessing, from at least one data feed, additional data corresponding to the plurality of protection records.

11. The modeling system of claim 1, wherein the operations further comprising:
causing a user interface to display the output comprising a prompt element for receiving user input.

12. The modeling system of claim 11, wherein the operations further comprising:
generating, during an active session between a plurality of users, a query according to the at least one action, the active session comprises an active connection between a first computing system of a first user and a second computing system of a second user; and
causing the user interface to display the query to at least the first computing system or the second computing system.

13. A modeling system for modeling unstructured data items using artificial intelligence (AI) models, comprising:
one or more memory devices having instructions stored thereon that, when executed by one or more processors, cause the one or more processors to perform operations comprising:
monitoring, using at least one data feed, multimedia data associated with at least one protection record, the at least one protection record corresponding to at least one protection product;
converting the multimedia data into a plurality of data items of the at least one protection record;
generating a prompt based upon the plurality of data items for one or more AI models, wherein generating the prompt comprises extracting one or more associations corresponding to contextual information and attribute information of the plurality of data items;
applying the plurality of data items and the prompt as input to the one or more AI models to cause the one or more AI models to generate an output regarding at least one of an occurrence prediction or a pattern identification within the plurality of data items, wherein the output comprises an update to at least one protection parameter of the at least one protection product; and
determining at least one action to apply the update to the at least one protection parameter of the at least one protection product, wherein the at least one action comprises a response to the plurality of data items and the prompt, the response causing a tuning of a probability metric of the occurrence prediction or a tuning of a frequency metric of the pattern identification.

14. The modeling system of claim 13, wherein the plurality of data items corresponds to non-relational data generated by a plurality of sources, and wherein applying the plurality of data items and the prompt as the input to the one or more AI models comprises:
transforming the plurality of data items into a plurality of feature vectors;
normalizing the plurality of feature vectors to a scale; and
inputting the normalized plurality of feature vectors into the one or more AI models to perform predictive and pattern recognition to cause the one or more AI models to generate the output.

15. The modeling system of claim 13, wherein the one or more AI models comprise a generative AI model, and wherein the generative AI model comprise at least one of (i) a supervised learning model trained on labeled protection records of the at least one protection record or (ii) an unsupervised learning model trained on unlabeled protection records of the at least one protection record.

16. The modeling system of claim 15, wherein the supervised learning model and the unsupervised learning model comprise at least one of (i) an association detector to assign the probability metric of the occurrence prediction, or (ii) a pattern tracker to assign the frequency metric of the pattern identification.

17. The modeling system of claim 15, wherein the generative AI model implements reinforcement learning, wherein the reinforcement learning comprises updating the generative AI model based upon receiving feedback on the output and the at least one action from a reward signal generated from performance metrics of the at least one protection record, the feedback corresponding to at least one user interaction with a user interface.

18. The modeling system of claim 13, wherein the update to the at least one protection parameter is at least one of updating a deductible parameter for at least one future protection product, updating a coverage parameter for the at least one future protection product, updating a processing protocol parameter for the at least one future protection product, or generating a new query for the at least one future protection product.

19. A computer-implemented method for modeling unstructured data items using artificial intelligence (AI) models, comprising:
receiving, using one or more processors and one or more computer-readable storage media having instructions stored thereon executable by the one or more processors, a plurality of unstructured data items associated with a plurality of protection records, the plurality of protection records corresponding to at least one protection product;
monitoring, using the one or more processors and using at least one data feed, multimedia unstructured data items associated with at least one protection record of the plurality of protection records, the at least one protection record corresponding to the at least one protection product;
converting, using the one or more processors, the multimedia unstructured data items into unstructured data items of the plurality of unstructured data items;
generating, using the one or more processors, a prompt based upon the plurality of unstructured data items for one or more AI models, wherein generating the prompt comprises extracting one or more associations corresponding to contextual information and attribute information of the plurality of unstructured data items;
applying, using the one or more processors, the plurality of unstructured data items and the prompt as input to the one or more AI models to cause the one or more AI models to generate an output regarding at least one of an occurrence prediction or a pattern identification within the plurality of unstructured data items, wherein the output comprises an update to at least one protection parameter of the at least one protection product; and
determining, using the one or more processors, at least one action to apply the update to the at least one protection parameter of the at least one protection product, wherein the at least one action comprises a response to the plurality of unstructured data items and the prompt, the response causing a tuning of a probability metric of the occurrence prediction or a tuning of a frequency metric of the pattern identification.

20. The computer-implemented method of claim 19, wherein the one or more AI models comprise a generative AI model, and wherein the generative AI model comprise at least one of (i) a supervised learning model trained on labeled protection records of the plurality of protection records or (ii) an unsupervised learning model trained on unlabeled protection records of the plurality of protection records.
